(19) United States
(12) Patent Application Publication
(10) Pub. No.: US 2025/0063991 A1
(43) Pub. Date: Feb. 27, 2025

(54) WORKING MACHINE

(71) Applicant: MAKITA CORPORATION, Anjo-shi (JP)

(72) Inventors: Ryo SUNAZUKA, Anjo-Shi (JP); Tatsuya Hata, Anjo-Shi (JP)

(73) Assignee: MAKITA CORPORATION, Anjo-shi (JP)

(21) Appl. No.: 18/809,983

(22) Filed: Aug. 20, 2024

(30) Foreign Application Priority Data
Aug. 25, 2023 (JP) 2023-137470
Aug. 25, 2023 (JP) 2023-137499
Jun. 7, 2024 (JP) 2024-093228

(51) Int. Cl. A01G 3/053; A01G 3/04; B25F 5/00; B25F 5/02

(52) U.S. Cl. CPC A01G 3/053; B25F 5/006; B25F 5/008; B25F 5/02; A01G 2003/0461

(57) ABSTRACT

A working machine may include a working unit including a working mechanism, an electric motor, and a motor housing, a control unit, a base, a rear housing, a front handle, and a rear handle. The base may include a passage. The motor housing may include an inner air inlet and an outer air outlet. The rear housing may include an outer air inlet and an inner air outlet. A cooling air passage may be defined in which air flows from the outer air inlet to the outer air outlet through an inside of the rear housing, the inner air outlet, the inside of the passage, the inner air inlet, and an inside of the motor housing. As viewed along a front-rear direction, the inner air inlet and the inner air outlet may overlap each other.

### REFERENCE TO RELATED APPLICATIONS

This application claims priority from Japanese Patent Application No. 2023-137499 filed on Aug. 25, 2023, Japanese Patent Application No. 2023-137470 filed on Aug. 25, 2023, and Japanese Patent Application No. 2024-93228 filed on Jun. 7, 2024. The entire content of the priority application is incorporated herein by reference.

### TECHNICAL FIELD

The art disclosed herein relates to working machines.

### BACKGROUND ART

US Patent Application Publication No. 2021/0107129 describes a working machine including: a working unit having a working mechanism, an electric motor configured to drive the working mechanism, and a motor housing that houses the electric motor; a control unit configured to control the electric motor; a rear housing attached to a rear portion of the motor housing; a front handle configured to be grasped by a user with one hand of the user; and a rear handle disposed on the rear housing and configured to be grasped by the user with the other hand of the user. The motor housing includes an air inlet that opens to the outside of the working machine and an air outlet that opens to the outside of the working machine. A cooling air passage is defined to extend from the air inlet to the air outlet via the inside of the rear housing.

### SUMMARY

When a working machine operates, foreign matters such as dust may be dispersed around the working machine. In the working machine described in US Patent Application Publication No. 2021/0107129, such foreign matters dispersed due to the operation of the working machine may enter the inside of the working machine through the air inlet defined in the motor housing. In order to prevent the entry of foreign matters into the working machine, it is conceivable to define the air inlet, which opens to the outside of the working machine, in the rear housing which is relatively far from the working mechanism. This configuration, however, requires the cooling air passage to extend not only in the motor housing but also in the rear housing. This may make the air flow in the cooling air passage less smoothly as compared to the working machine of US Patent Application Publication No. 2021/0107129 in which the cooling air passage does not extend in the rear housing. This may lead to an insufficient amount of air (cooling air) flowing in the cooling air passage, and thus may result in insufficient cooling for the electric motor. The disclosure herein provides technology that enables sufficient cooling for an electric motor while preventing the entry of foreign matters into a working machine.

A working machine disclosed herein may comprise a working unit including a working mechanism, an electric motor configured to drive the working mechanism, and a motor housing that houses the electric motor, a control unit configured to control the electric motor, a base supporting the working unit, a rear housing attached to a rear portion of the base, a front handle disposed on the base and configured to be grasped by a user with one hand of the user, and a rear handle disposed on the rear housing and configured to be grasped by the user with the other hand of the user. The base may comprise a passage. The motor housing may comprise an inner air inlet that opens to an inside of the passage and an outer air outlet that opens to outside of the working machine. The rear housing may comprise an outer air inlet that opens to the outside of the working machine and an inner air outlet that opens to the inside of the passage. A cooling air passage may be defined in which air flows from the outer air inlet to the outer air outlet through an inside of the rear housing, the inner air outlet, the inside of the passage, the inner air inlet, and an inside of the motor housing. As viewed along a front-rear direction, the inner air inlet and the inner air outlet may overlap each other.

If the inner air inlet and the inner air outlet do not overlap each other as viewed along the front-rear direction, air flowing out of the inner air outlet may not smoothly flow into the inner air inlet. This may lead to an insufficient amount of cooling air and thus may result in insufficient cooling for the electric motor. Since the inner air inlet and the inner air outlet overlap each other as viewed along the front-rear direction in the configuration above, the air flowing out of the inner air outlet smoothly flows into the inner air inlet. This increases the amount of cooling air, and thus the electric motor can thereby be cooled sufficiently. Further, since the outer air inlet, which opens to the outside of the working machine, is defined in the rear housing located far from the working mechanism in the above configuration, foreign matters dispersed due to the operation of the working machine are prevented from entering the working machine.

### BRIEF DESCRIPTION OF DRAWINGS

FIG. 1 shows a perspective view of a hedge trimmer 2 according to a first embodiment with a rear housing 12 in a normal position, as viewed from the upper front right side.

FIG. 2 shows a right side view of an internal structure of the hedge trimmer 2 according to the first embodiment.

FIG. 3 shows a perspective view of an internal structure of the rear housing 12 of the hedge trimmer 2 according to the first embodiment, as viewed from the upper rear left side.

FIG. 4 shows a perspective view of the internal structure of the rear housing 12 of the hedge trimmer 2 according to the first embodiment, as viewed from the upper rear left side.

FIG. 5 shows a perspective view of the hedge trimmer 2 according to the first embodiment with the rear housing 12 in a rotated position, as viewed from the upper front right side.

FIG. 6 shows an exploded view of a front portion of the hedge trimmer 2 according to the first embodiment.

FIG. 7 shows a perspective view of vibration damping member 90a, 90b, 90c according to the first embodiment.

FIG. 8 shows a side view of the vibration damping member 90a, 90b, 90c according to the first embodiment.

FIG. 9 shows a perspective view of the vibration damping member 90a, 90b, 90c according to the first embodiment.

FIG. 10 shows a perspective cross-sectional view of the vibration damping member 90a, 90b, 90c according to the first embodiment.

FIG. 11 shows the vibration damping member 90a according to the first embodiment, a first mount element 128, a second mount element 134, and a third mount element 140.

FIG. 12 shows the vibration damping member 90a according to the first embodiment attached to the first mount element 128, the second mount element 134, and the third mount element 140.

FIG. 13 shows the vibration damping member 90b according to the first embodiment, a first mount element 146, a second mount element 152, and a third mount element 158.

FIG. 14 shows the vibration damping member 90c according to the first embodiment, a first mount element 164, a second mount element 168, and a third mount element 174.

FIG. 15 shows the vibration damping member 90c according to the first embodiment attached to the first mount element 164, the second mount element 168, and the third mount element 174.

FIG. 16A shows a cross-sectional view of the vibration damping member 90a, 90b, 90c according to the first embodiment along a line A-A in FIG. 8.

FIG. 16B shows a cross-sectional view of the vibration damping member 90a, 90b, 90c according to the first embodiment along a line B-B in FIG. 8.

FIG. 16C shows a cross-sectional view of the vibration damping member 90a, 90b, 90c according to the first embodiment along a line C-C in FIG. 8.

FIG. 16D shows a cross-sectional view of the vibration damping member 90a, 90b, 90c according to the first embodiment along a line D-D in FIG. 8.

FIG. 16E shows a cross-sectional view of the vibration damping member 90a, 90b, 90c according to the first embodiment along a line E-E in FIG. 8.

FIG. 16F shows a cross-sectional view of the vibration damping member 90a, 90b, 90c according to the first embodiment along a line F-F in FIG. 8.

FIG. 17 shows an exploded view of a motor housing 22 of the hedge trimmer 2 according to the first embodiment.

FIG. 18 shows an enlarged cross-sectional view illustrating a cooling air passage F in the hedge trimmer 2 according to the first embodiment.

FIG. 19 shows a positional relationship between an air inlet 188 of the motor housing 22 and an air outlet 196 of the rear housing 12 within a passage 192 in the hedge trimmer 2 according to the first embodiment.

FIG. 20 shows the rear housing 12 according to the first embodiment and a battery pack B attached to a battery receptacle 38 of the rear housing 12 as viewed in a direction of a rotation axis RA.

FIG. 21 shows a perspective view of vibration damping member 90a, 90b, 90c according to a variant.

FIG. 22 shows a perspective view of a hedge trimmer 302 according to a second embodiment with a rear housing 312 in a normal position, as viewed from the upper front right side.

FIG. 23 shows a right side view of an internal structure of the hedge trimmer 302 according to the second embodiment.

FIG. 24 shows a perspective view of an internal structure of the rear housing 312 of the hedge trimmer 302 according to the second embodiment, as viewed from the upper rear left side.

FIG. 25 shows a perspective view of the internal structure of the rear housing 312 of the hedge trimmer 302 according to the second embodiment, as viewed from the upper rear left side.

FIG. 26 shows a perspective view of the hedge trimmer 302 according to the second embodiment with the rear housing 312 in a rotated position, as viewed from the upper front right side.

FIG. 27 shows an exploded view of a front portion of the hedge trimmer 302 according to the second embodiment.

FIG. 28 shows an exploded view of a motor housing 322 of the hedge trimmer 302 according to the second embodiment.

FIG. 29 shows an enlarged cross-sectional view illustrating a cooling air passage F′ in the hedge trimmer 302 according to the second embodiment.

### DESCRIPTION

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved working machines as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, the control unit may be housed in the rear housing and located in the cooling air passage.

The configuration above allows not only the electric motor but also the control unit to be cooled by cooling air.

In one or more embodiments, the cooling air passage may comprise a passage section defined in the rear housing and extending in the front-rear direction. The control unit may be located in the passage section such that a longitudinal direction of the control unit is along the front-rear direction.

The configuration above allows the control unit to be efficiently cooled since the cooling air flows along the longitudinal direction of the control unit.

In one or more embodiments, the rear housing may be attached to the base such that the rear housing is rotatable about a predetermined rotation axis. The rear housing may be movable relative to the base between a normal position and a rotated position in which the rear housing has been rotated about the rotation axis from the normal position.

The configuration above allows the user to change the position of the rear housing relative to the base to change the positional relationship between the front handle and the rear handle. For example, the user can change the positional relationship between the front handle and the rear handle to hold the working machine in a comfortable posture.

In one or more embodiments, the rear housing may comprise a shaft portion extending along the rotation axis. The base may comprise a shaft holding portion that holds the shaft portion such that the shaft portion is rotatable about the rotation axis. The shaft portion may comprise a through hole that extends through the shaft portion to communicate the inside of the rear housing with outside of the rear housing. An opening of the through hole that is directed toward the outside of the rear housing may function as the inner air outlet.

If the inner air outlet is located far from the rotation axis, the positional relationship between the inner air inlet and the inner air outlet is significantly changed when the rear housing is rotated relative to the base. Thus, depending on the position of the rear housing relative to the base, the air flowing out of the inner air outlet may not smoothly flow into the inner air inlet. In the configuration above, the inner air outlet is defined in the shaft portion and thus near the rotation axis. Therefore, the positional relationship between the inner air inlet and the inner air outlet is not changed much even when the rear housing is rotated relative to the base. Thus, the configuration above can smoothly guide the air flowing out of the inner air outlet into the inner air inlet, regardless of the position of the rear housing relative to the base.

In one or more embodiments, the electric motor may be an inner rotor brushless motor comprising a stator, a rotor located inward of the stator, and an output shaft fixed to the rotor. When the motor housing is removed from the working machine, an outer surface of the stator may be exposed to the outside of the working machine.

If the outer surface of the stator is covered by a member different from the motor housing, heat may not be released from the stator (i.e., the electric motor). The configuration above allows release of heat from the electric motor since the motor housing is the only member that covers the outer surface of the stator.

In one or more embodiments, the working mechanism may comprise a pair of blades extending in the front-rear direction. The blades may be configured to reciprocate relative to each other in the front-rear direction when driven by the electric motor.

The configuration above prevents foreign matters dispersed due to the operation of the pair of blades from entering the inside of the working machine, while sufficiently cooling the electric motor.

In one or more embodiments, the working unit may further comprise a mechanism housing supporting the working mechanism. The mechanism housing may comprise a facing surface exposed to the outside of the working machine and facing the outer air outlet.

In the configuration above, the mechanism housing is located to face the outer air outlet. This makes foreign matters (e.g., dust, chips) outside the working machine unlikely to reach the outer air outlet and thus suppresses the entry of foreign matters through the outer air outlet from the outside into the inside of the working machine. Further, in the configuration above, air from the outer air outlet hits the facing surface immediately after flowing out of the outer air outlet and thus its speed is reduced. This prevents the air from the outer air outlet from bursting toward the user's body and thus prevents the user from feeling uncomfortable.

In one or more embodiments, the base may comprise a bottom surface that faces a flat surface when the working machine is placed on the flat surface. A direction from an inside of the working machine to the outside of the working machine via the outer air outlet may be along a direction in which the bottom surface faces.

Generally, a handle configured to be gripped by the user, etc. is not located on the bottom surface of the base. Therefore, when the user uses the working machine, the user's body is not expected to be in a space the bottom surface of the base faces. In the configuration above, the direction from the inside to the outside of the working machine via the outer air outlet (i.e., the direction in which the air from the outer air outlet flows) is toward the space the bottom surface of the base faces (i.e., the space in which the user's body is not expected to exist). This prevents the air from the outer air outlet from bursting toward the user's body and thus prevents the user from feeling uncomfortable.

In one or more embodiments, the rear housing may comprise a battery receptacle to which a battery pack is detachably attached. The outer air inlet may face the battery pack attached to the battery receptacle.

In the configuration above, the battery pack is located to face the outer air inlet. This makes foreign matters (e.g., dust, chips) outside the working machine unlikely to reach the outer air inlet and thus suppresses the entry of foreign matters through the outer air inlet from the outside into the inside of the working machine.

Another working machine disclosed herein may comprise an electric motor, a working mechanism configured to be driven by the electric motor, a base supporting the working mechanism, a rear housing that is attached to a rear portion of the base such that the rear housing is rotatable about a predetermined rotation axis and is movable relative to the base between a normal position and a rotated position in which the rear housing has been rotated about the rotation axis from the normal position, a front handle disposed on the base and configured to be grasped by a user with one hand of the user, a rear handle disposed on the rear housing and configured to be grasped by the user with the other hand of the user, and a battery receptacle disposed in the rear housing and to which a battery pack is detachably attached. In a state where the battery pack is attached to the battery receptacle, the battery pack may be located on the rotation axis.

In the configuration above, the battery pack is attached to the rear housing such that it is located on the rotation axis. Thus, a moment of inertia of the battery pack about the rotation axis is relatively small. Therefore, the user can rotate the rear housing together with the battery pack with a relatively small force. Thus, the usability of the working machine can be improved.

In one or more embodiments, in a state where the rear housing is in the normal position, the battery receptacle may be located in the rear portion of the rear housing.

When gripping the front handle and the rear handle, the user can easily handle the working machine with the center of gravity of the working machine located near the user's body. However, the center of gravity of the working machine tends to be located closer to the base which supports the working mechanism (i.e., the front portion of the working machine) relative to the body of user gripping the front and rear handles. Since the battery pack is attached to the rear portion of the rear housing in the configuration above, the weight of the battery pack brings the center of gravity of the working machine closer to the rear housing (i.e., the rear portion of the working machine). Thus, the center of gravity of the working machine is located closer to the body of the user gripping the front and rear handles. This allows the user to easily handle the working machine.

In one or more embodiments, in a state where the rear housing is in the normal position and the battery pack is attached to the battery receptacle, a center of gravity of the battery pack may be located rearward of a rear end of the rear handle.

In the configuration above, the center of gravity of the battery pack is located rearward of the user's hand gripping the rear handle, regardless of which part of the rear handle the user grips. That is, the center of gravity of the battery pack is located rearward of the user's body. This allows the center of gravity of the working machine to be located closer to the user's body.

In one or more embodiments, in a state where the rear housing is in the normal position, the rear handle may be located on an upper portion of the rear housing and extends in a front-rear direction. In a state where the rear housing is in the normal position, the battery pack may be attached to the battery receptacle by being slid relative to the battery receptacle in a sliding direction from an upper rear end of the battery receptacle toward a lower front end of the battery receptacle.

The upper portion of the rear housing on which the rear handle configured to be gripped by the user is located needs to have a certain length in the front-rear direction. Conversely, the lower portion of the rear housing on which the rear handle is not located may have a short length in the front-rear direction. In the configuration above, the battery receptacle located in the rear portion of the rear housing has a slanted shape with its lower end located forward of its upper end. Thus, in the front-rear direction, the upper portion of the rear housing can have a certain length and the lower portion of the rear housing can have a relatively short length.

In one or more embodiments, in a state where the rear housing is in the normal position and the battery pack is attached to the battery receptacle, a center of gravity of the working machine may be located rearward of a rear end of the front handle and forward of a front end of the rear handle.

When the center of gravity of the working machine is located between the front and rear handles, the center of gravity of the working machine is close to the body of the user gripping the front and rear handles. This allows the user to easily handle the working machine.

In one or more embodiments, as viewed along a direction of the rotation axis, the rear housing and the battery pack may be located within an imaginary circle with a radius of 13 cm about the rotation axis.

In the configuration above, the moments of inertia of the rear housing and the battery pack about the rotation axis are small. Therefore, the user can rotate the rear housing together with the battery pack with a small force. Thus, the usability of the working machine is improved.

In one or more embodiments, the base may comprise a front support supporting the working mechanism, a rear support supporting the working mechanism and located rearward of the front support, and an arm extending on a side of the working mechanism and connecting the front support to the rear support.

In the configuration above, the base is compact and thus is less likely to interfere with the user's body and an object while the user is using the working machine. Thus, the usability of the working machine is improved.

In one or more embodiments, the arm may comprise a left arm extending on a left side of the working mechanism and connecting the front support to the rear support, and a right arm extending on a right side of the working mechanism and connecting the front support to the rear support.

If a single arm connects the front support to the rear support, the arm may be deteriorated when large stress is applied thereto during use of the working machine by the user. Since the left arm and the right arm connect the front support to the rear support in the configuration above, stress is distributed to the left arm and the right arm. This prevents the left arm and the right arm from individually receiving large stress and thus suppresses the deterioration of the left and right arms.

In one or more embodiments, the working mechanism may comprise a pair of blades extending in the front-rear direction. The blades may be configured to reciprocate relative to each other in the front-rear direction when driven by the electric motor.

In the configuration above, the pair of blades is located to be forward of the front handle and extend forward. In this case, the center of gravity of the working machine is more likely to be located closer to the base (i.e., the front portion of the working machine). Since the battery pack is attached to the rear portion of the rear housing in the configuration above, the weight of the battery pack allows the center of gravity of the working machine to be located closer to the rear housing (i.e., the rear portion of the working machine). Thus, the center of gravity of the working machine is located closer to the body of the user gripping the front and rear handles. This allows the user to easily handle the working machine.

### First Embodiment: Hedge Trimmer 2

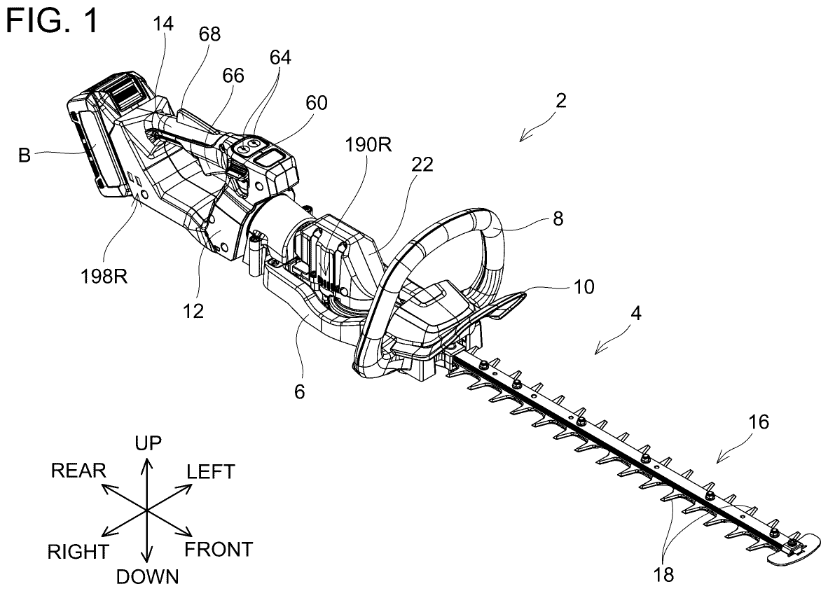

As shown in FIG. 1, a working machine according to this embodiment is a hedge trimmer 2. The hedge trimmer 2 is a gardening tool used mainly to prune hedges and plants. The hedge trimmer 2 comprises a working unit 4, a base 6 configured to support the working unit 4, a front handle 8 located on the base 6, a hand guard 10 configured to protect a hand of a user that grasps the front handle 8, a rear housing 12 attached to a rear portion of the base 6, and a rear handle 14 located on the rear housing 12.

The working unit 4 comprises a pair of shear blades 16. The pair of shear blades 16 extends linearly and comprises a plurality of cutting edges 18 along their longitudinal direction. The shear blades 16 reciprocate with each other to prune hedges and plants with the cutting edges 18. In this embodiment, regarding the longitudinal direction of the pair of shear blades 16, the direction from the base 6 toward the pair of shear blades 16 is termed a front direction and the direction from the pair of shear blades 16 toward the base 6 is termed a rear direction. Further, a direction that is orthogonal to the front-rear direction and parallel to a plane on which the cutting edges 18 of the pair of shear blades 16 lie is termed a right-left direction. Furthermore, regarding the direction orthogonal to the front-rear direction and the right-left direction, the direction from the pair of shear blades 16 toward the hand guard 10 is termed an up direction and the direction from the hand guard 10 toward the pair of shear blades 16 is termed a down direction.

The front handle 8 is located on a front portion of the base 6 and has a substantially inverted U-shape. The front handle 8 extends above and on the right and left sides of the base 6. The outer surface of the front handle 8 has a substantially cylindrical shape. The rear handle 14 is located on an upper portion of the rear housing 12 and extends linearly along the front-rear direction. The outer surface of the rear handle 14 has a substantially cylindrical shape. The user grasps the front handle 8 with one hand and the rear handle 14 with the other hand to carry the hedge trimmer 2.

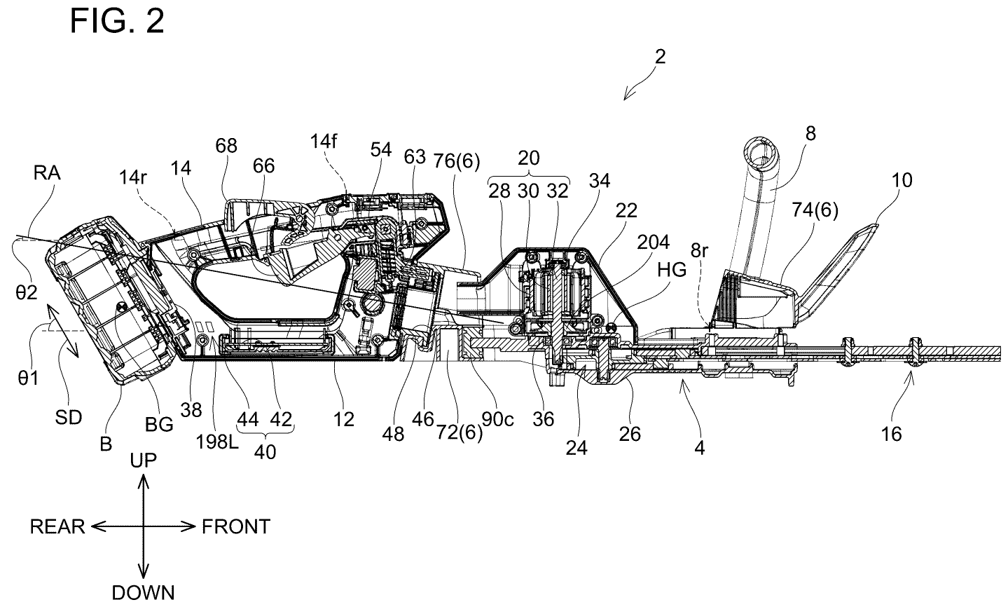

As shown in FIG. 2, the working unit 4 further comprises an electric motor 20, a motor housing 22, a power transmission mechanism 24, and a mechanism housing 26. The electric motor 20 is an inner rotor brushless motor comprising, for example, a stator 28, a rotor 30 disposed inward of the stator 28, and an output shaft 32 fixed to the rotor 30. The electric motor 20 is housed in the motor housing 22. The motor housing 22 is fixed to an upper portion of the mechanism housing 26. The output shaft 32 of the electric motor 20 is rotatably held by the motor housing 22 via a bearing 34 and also rotatably held by the mechanism housing 26 via a bearing 36. The output shaft 32 extends in the up-down direction, and a part thereof is in the motor housing 22 and another part thereof is in the mechanism housing 26. The mechanism housing 26 houses the power transmission mechanism 24 and supports the pair of shear blades 16. The output shaft 32 of the electric motor 20 is coupled to the pair of shear blades 16 via the power transmission mechanism 24. The power transmission mechanism 24 is for example a crank/cam mechanism and converts the rotation of the output shaft 32 to the reciprocation of each shear blade 16. The reciprocation direction of the shear blades 16 is along the front-rear direction.

A battery receptacle 38 to which a battery pack B is removably attached is located in a rear portion of the rear housing 12. To attach the battery pack B to the battery receptacle 38, the battery pack B is slid relative to the battery receptacle 38 in a sliding direction SD from the upper rear end toward the lower front end of the battery receptacle 38. In the right side view, an inclination angle θ1 of the sliding direction SD relative to the front-rear direction is for example in the range from 45 degrees to 90 degrees, and it is 60 degrees in this embodiment.

A control unit 40 configured to control units/parts of the hedge trimmer 2 is housed in a lower portion of the rear housing 12. The control unit 40 comprises a control board 42 and a controller casing 44 housing the control board 42 therein. The control board 42 includes for example a microcomputer including a CPU, a ROM, and a RAM and an inverter circuit including a plurality of switching elements (e.g., FETs). For example, the control unit 40 is configured to convert DC power from the battery pack B to three-phase AC power and supply it to the electric motor 20. The control unit 40 has a substantially flat-plate shape extending along the right-left direction. The control unit 40 is arranged such that its longitudinal direction is along the front-rear direction.

The rear housing 12 comprises a substantially cylindrical shaft portion 46. The shaft portion 46 is located in a front portion of the rear housing 12. The base 6 comprises a shaft holding portion 48 that holds the shaft portion 46 such that the shaft portion 46 is rotatable about a rotation axis RA. The shaft holding portion 48 is located in the rear portion of the base 6. The rotation axis RA lies on a plane orthogonal to the right-left direction and is inclined downward from the rear toward the front. In the right side view, an inclination angle θ2 of the rotation axis RA relative to the front-rear direction is for example in the range from 0 degrees to 30 degrees, and it is 10 degrees in this embodiment. The rotation axis RA passes the battery pack B attached to the battery receptacle 38. That is, the battery pack B attached to the battery receptacle 38 is located on the rotation axis RA.

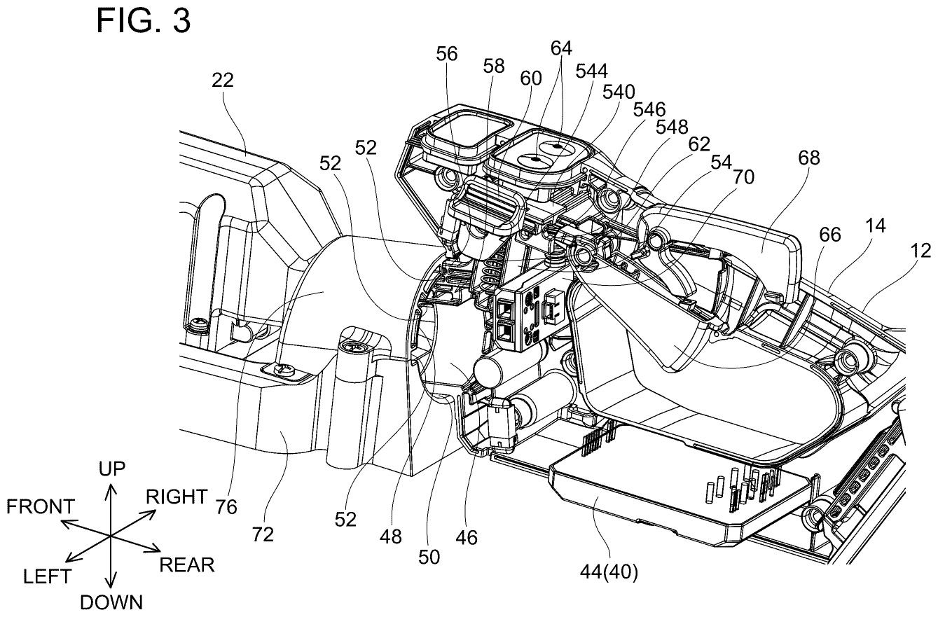

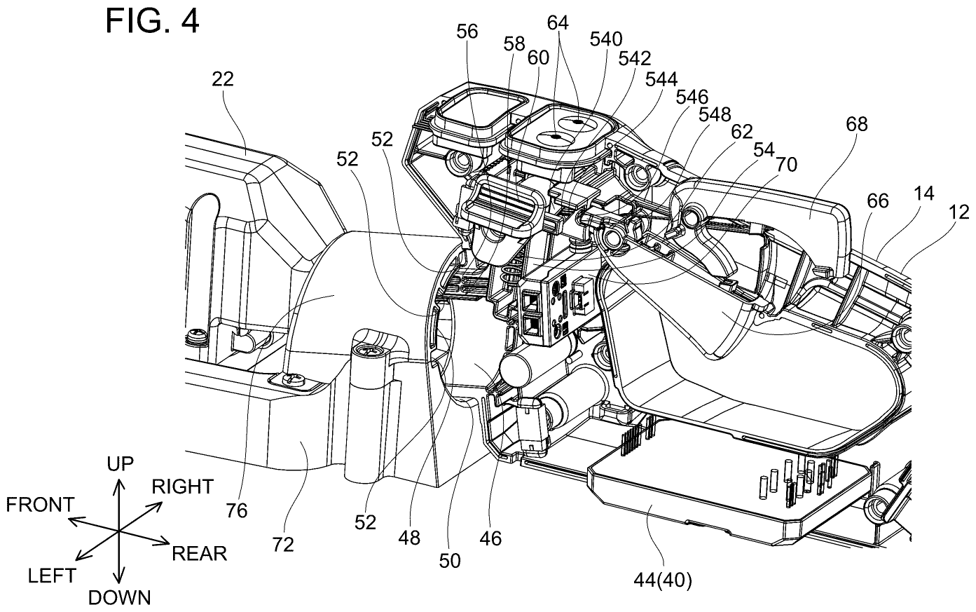

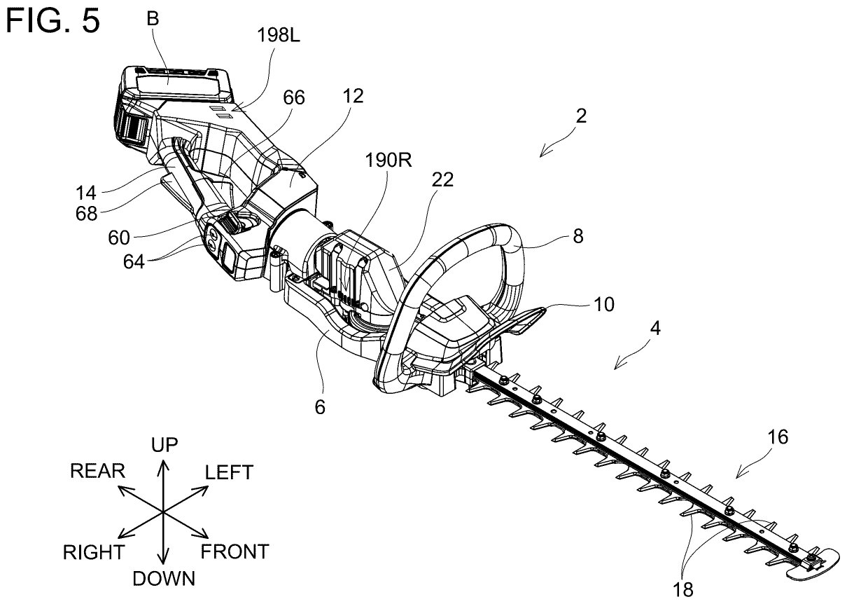

As shown in FIG. 3, the shaft holding portion 48 comprises a cylindrical surface 50 that holds the outer circumferential surface of the shaft portion 46 such that the shaft portion 46 is rotatable and a plurality of engagement grooves 52 (only partially shown) recessed from the cylindrical surface 50 in a radially outward direction of the rotation axis RA (see FIG. 2). In this embodiment, there are five engagement grooves 52. The engagement grooves 52 each extend along the rotation axis RA. In the circumferential direction of the rotation axis RA, the engagement grooves 52 are spaced from each other at predetermined intervals (e.g., at intervals at ⅛ of circumference). A rotation locking member 54 is located on the rear housing 12, and the rotation locking member 54 is configured to lock the rotation of the shaft portion 46 relative to the base 6 (i.e., the rotation of the rear housing 12 relative to the base 6). The rotation locking member 54 comprises a lock piece 56 extending along the rotation axis RA. The shaft portion 46 includes a receiving groove 58 that is recessed radially inward from the outer circumferential surface of the shaft portion 46 and configured to receive the lock piece 56. The receiving groove 58 extends along the rotation axis RA. When the receiving groove 58 and one of the engagement grooves 52 face each other in the radial direction of the rotation axis RA, the rotation locking member 54 is slidable between a lock position where the lock piece 56 is received by the engagement groove 52 as shown in FIG. 3 and an unlock position where the lock piece 56 is received by the receiving groove 58 as shown in FIG. 4. A manipulation member 60 is fixed to the rotation locking member 54. As shown in FIGS. 1 and 5, the manipulation member 60 is exposed to right and left outer surfaces of the rear housing 12 and is slidable along the outer surface of the rear housing 12. The user can slide the rotation locking member 54 by manipulating the manipulation member 60. As shown in FIGS. 3 and 4, a coil spring 62 is attached to the rotation locking member 54. The lower end of the coil spring 62 contacts a support projection 63 (see FIG. 2) formed on the inner wall of the rear housing 12. The coil spring 62 biases the rotation locking member 54 upward relative to the support projection 63. Thus, when the manipulation member 60 is not manipulated by the user, the rotation locking member 54 is retained in the lock position shown in FIG. 3 by the biasing force of the coil spring 62. When the rotation locking member 54 is in the lock position, the rear housing 12 is mechanically locked to the base 6 and the rear housing 12 is thereby prohibited from rotating relative to the base 6. When the user pushes down the manipulation member 60 against the biasing force of the coil spring 62, the rotation locking member 54 moves to the unlock position shown in FIG. 4. When the rotation locking member 54 is in the unlock position, the rear housing 12 is not locked to the base 6 and the rear housing 12 is thus permitted to rotate relative to the base 6.

The user can change the position of the rear housing 12 relative to the base 6 by rotating the rear housing 12 to engage the lock piece 56 with another engagement groove 52 after the rotation locking member 54 has moved to the unlock position. Thereby, the position of the rear housing 12 can be changed from the normal position shown in FIG. 1 to for example a rotated position shown in FIG. 5. In the following description, the rear housing 12 is in the normal position shown in FIG. 1 unless otherwise stated.

As shown in FIG. 3, a manipulation button 64, a trigger lever 66, and a lock-off lever 68 are located on the rear housing 12. The manipulation button 64 is located on the upper surface of the rear handle 14. By manipulating the manipulation button 64, the user can switch on/off of the main power of the hedge trimmer 2, change the rotation speed of the electric motor 20, cause the electric motor 20 to rotate in the reverse direction, etc. The trigger lever 66 is located on a lower portion of the rear handle 14 such that the user can manipulate it with the index finger of the hand grasping the rear handle 14. The lock-off lever 68 is located on an upper portion of the rear handle 14 such that the user can manipulate it with the palm of the hand grasping the rear handle 14. The trigger lever 66 is usually mechanically locked by the lock-off lever 68. When the lock-off lever 68 is pushed, the trigger lever 66 is unlocked and thereby permitted to be pulled up. When the trigger lever 66 is pulled up, a microswitch 70 housed in the rear housing 12 is thereby pressed. When the microswitch 70 is pressed while the main power of the hedge trimmer 2 is on, the control unit 40 actuates the electric motor 20 to drive the pair of shear blades 16. When the trigger lever 66 is released, the pressing on the microswitch 70 is released. In response to this, the control unit 40 stops the electric motor 20 to stop the pair of shear blades 16. As above, the user can actuate the pair of shear blades 16 by pushing the lock-off lever 68 and pulling up the trigger lever 66 while the main power of the hedge trimmer 2 is on.

A slider 540 is coupled to the rotation locking member 54, and the slider 540 is held by the rear housing 12 such that the slider 540 is slidable along the front-rear direction. The slider 540 is coupled to the rotation locking member 54 by inserting a pin 542 of the rotation locking member 54 into an elongated hole 544 of the slider 540. As the rotation locking member 54 slides, the pin 542 moves along the elongated hole 544 and thus the slider 540 slides. The slider 540 includes a notch 546 in a rear portion of the slider 540. The trigger lever 66 includes a projection 548 configured to be insertable to the notch 546. When the rotation locking member 54 is in the lock position as shown in FIG. 3, the slider 540 does not mechanically interfere with the trigger lever 66. When the rotation locking member 54 moves to the unlock position as shown in FIG. 4, the slider 540 moves rearward and the projection 548 of the trigger lever 66 is inserted into the notch 546. The trigger lever 66 is thereby mechanically locked. Thus, when the user changes the position of the rear housing 12 relative to the base 6, the trigger lever 66 cannot be manipulated and the pair of shear blades 16 is thus prohibited from being driven.

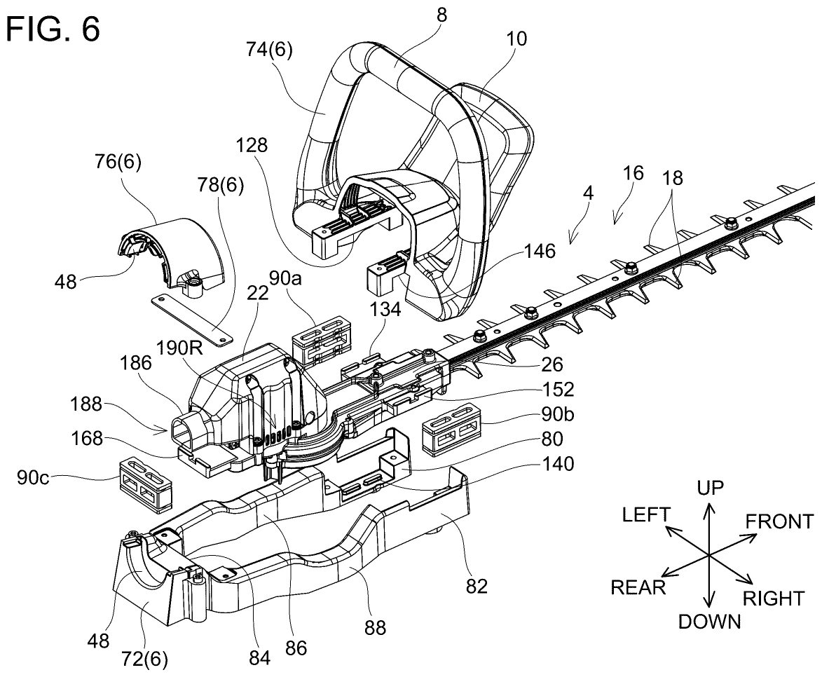

As shown in FIG. 6, the base 6 comprises a base body 72, a handle member 74, a semicylindrical member 76, and a plate member 78. The base body 72, the handle member 74, the semicylindrical member 76, and the plate member 78 are fixed to each other with screws (not shown). The handle member 74 forms the front handle 8 and the hand guard 10. The base 6 comprises a left support 80 supporting a left portion of the mechanism housing 26 via a vibration damping member 90a, a right support 82 supporting a right portion of the mechanism housing 26 via a vibration damping member 90b, a rear support 84 supporting a rear portion of the mechanism housing 26 via a vibration damping member 90c, a left arm 86 extending on the left side of the mechanism housing 26 and connecting the left support 80 to the rear support 84, and a right arm 88 extending on the right side of the mechanism housing 26 and connecting the right support 82 to the rear support 84.

### Vibration Damping Members 90a, 90b, 90c

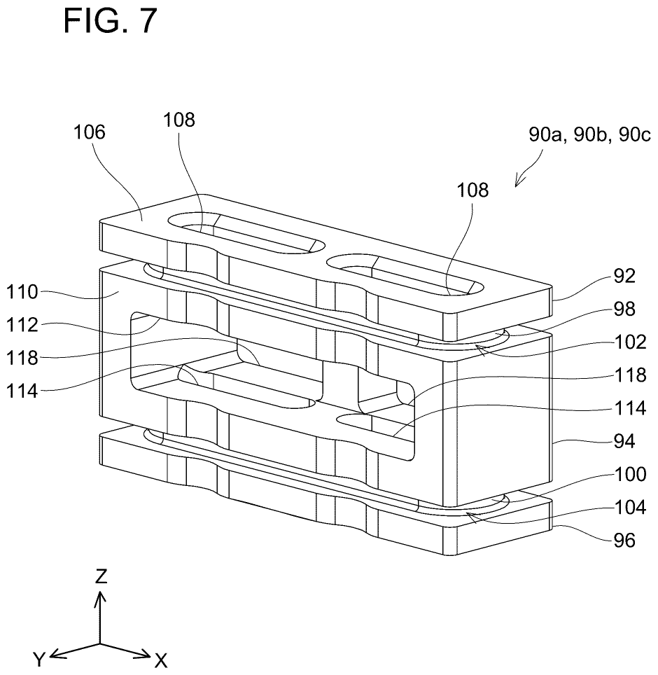

As shown in FIG. 7, the vibration damping members 90a, 90b, 90c each have a substantially cuboid shape. The vibration damping members 90a, 90b, 90c are constituted of a rubber material (i.e., silicon rubber). The vibration damping members 90a, 90b, 90c are manufactured for example by injection molding. In this embodiment, a length direction, a width direction, and a height direction of the vibration damping members 90a, 90b, 90c are defined as X direction, Y direction, and Z direction, respectively. The dimension of each vibration damping member 90a, 90b, 90c in X direction is for example in the range from 20 mm to 70 mm, and it is 50 mm in this embodiment. The dimension of each vibration damping member 90a, 90b, 90c in Y direction is for example in the range from 10 mm to 30 mm, and it is 15 mm in this embodiment. The dimension of each vibration damping member 90a, 90b, 90c in Z direction is for example in the range from 10 mm to 40 mm, and it is 25 mm in this embodiment. Each of the vibration damping members 90a, 90b, 90c is symmetric with respect to X and Z directions. Therefore, the following description of the vibration damping members 90a, 90b, 90c holds true even when +X direction and −X direction are interchanged and/or +Z direction and −Z direction are interchanged.

The vibration damping members 90a, 90b, 90c comprise common elements. Therefore, hereinafter, the elements of the vibration damping members 90a, 90b, 90c are labeled with same reference signs. It should be noted that only the configuration of the vibration damping member 90a is described hereinafter but the vibration damping members 90b, 90c have the same configuration unless otherwise stated.

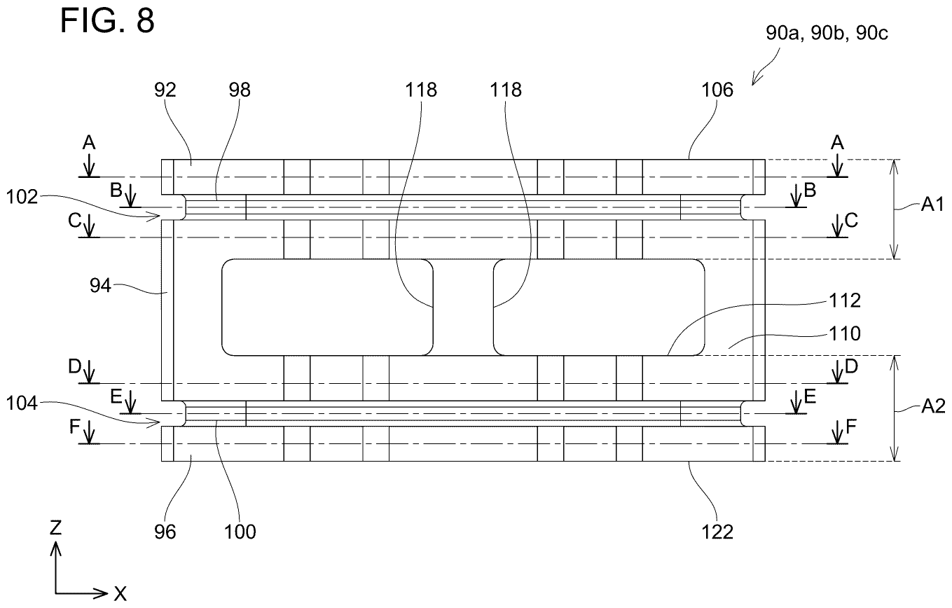

As shown in FIG. 8, the vibration damping member 90a comprises a first mount portion 92, a second mount portion 94 offset from the first mount portion 92 in-Z direction, a third mount portion 96 offset from the second mount portion 94 in-Z direction, a first connection portion 98 connecting the first mount portion 92 to the second mount portion 94, and a second connection portion 100 connecting the second mount portion 94 to the third mount portion 96. A first recessed groove 102 is defined in a portion of the outer surface of the vibration damping member 90a that corresponds to the outer surface of the first connection portion 98. A second recessed groove 104 is defined in a portion of the outer surface of the vibration damping member 90a that corresponds to the outer surface of the second connection portion 100. The first recessed groove 102 and the second recessed groove 104 both extend along the full periphery of the vibration damping member 90a with respect to an X-Y plane.

As shown in FIG. 7, the first mount portion 92 has a plate shape expanding along the X-Y plane. The first mount portion 92 comprises a mount surface 106 oriented in +Z direction and a plurality of mount holes 108 recessed in-Z direction from the mount surface 106. The mount holes 108 are elongated holes each having a longitudinal direction along X direction.

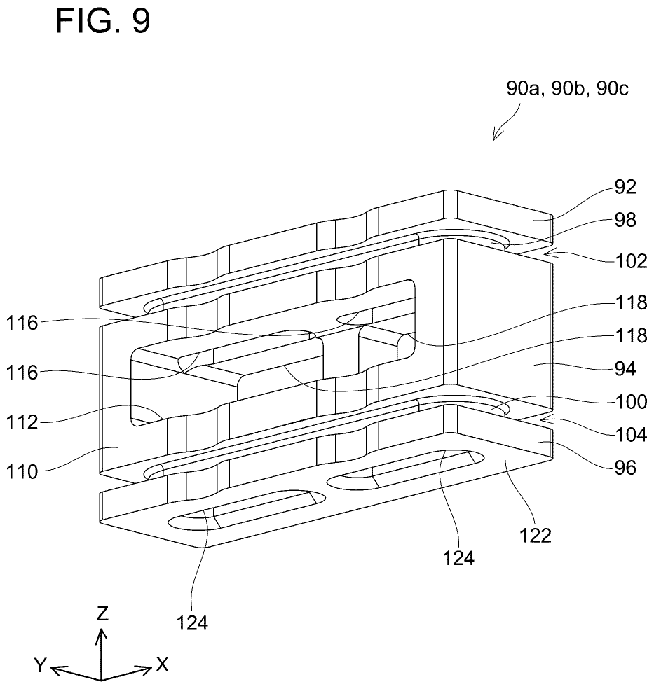

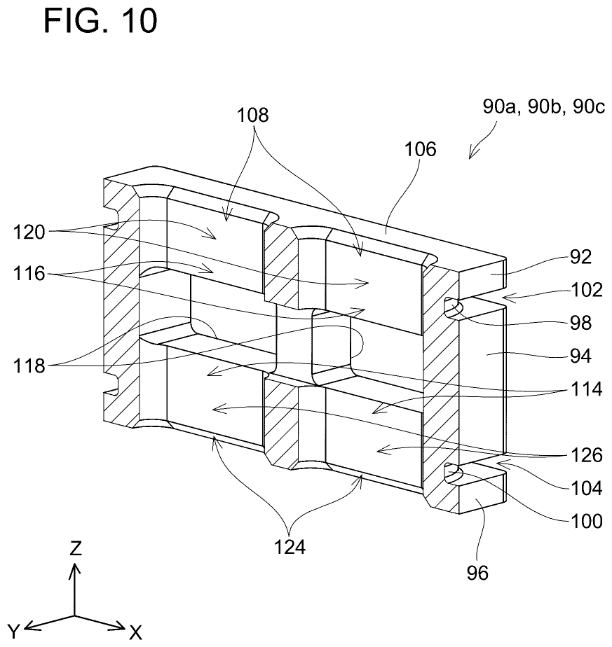

The second mount portion 94 has a substantially cuboid shape having the length direction along X direction, the width direction along Y direction, and the height direction along Z direction. The second mount portion 94 comprises an end surface 110 oriented in +Y direction, a mount recess 112 recessed in-Y direction from the end surface 110, a plurality of mount holes 114 recessed in −Z direction from a wall surface of the mount recess 112, a plurality of mount holes 116 recessed in +Z direction from a wall surface of the mount recess 112 (see FIG. 9), and a plurality of lightening holes 118 penetrating the bottom surface of the mount recess 112 in −Y direction. As shown in FIG. 10, each mount hole 116 is connected to a corresponding mount hole 108 in the first mount portion 92 via a hollow space 120 defined in the first connection portion 98. In this embodiment, wall surfaces defining the mount holes 116, wall surfaces defining the hollow spaces 120, and wall surfaces defining the mount holes 108 are smoothly connected to each other.

As shown in FIG. 9, as with the first mount portion 92, the third mount portion 96 has a plate shape expanding along the X-Y plane. The third mount portion 96 comprises a mount surface 122 oriented in −Z direction and a plurality of mount holes 124 recessed in +Z direction from the mount surface 122. The mount holes 124 are elongated holes each having a longitudinal direction along X direction. As shown in FIG. 10, each mount hole 124 is connected to a corresponding mount hole 114 in the second mount portion 94 via a hollow space 126 defined in the second connection portion 100. In this embodiment, wall surfaces defining the mount holes 124, wall surfaces defining the hollow spaces 126, and wall surfaces defining the mount holes 114 are smoothly connected to each other.

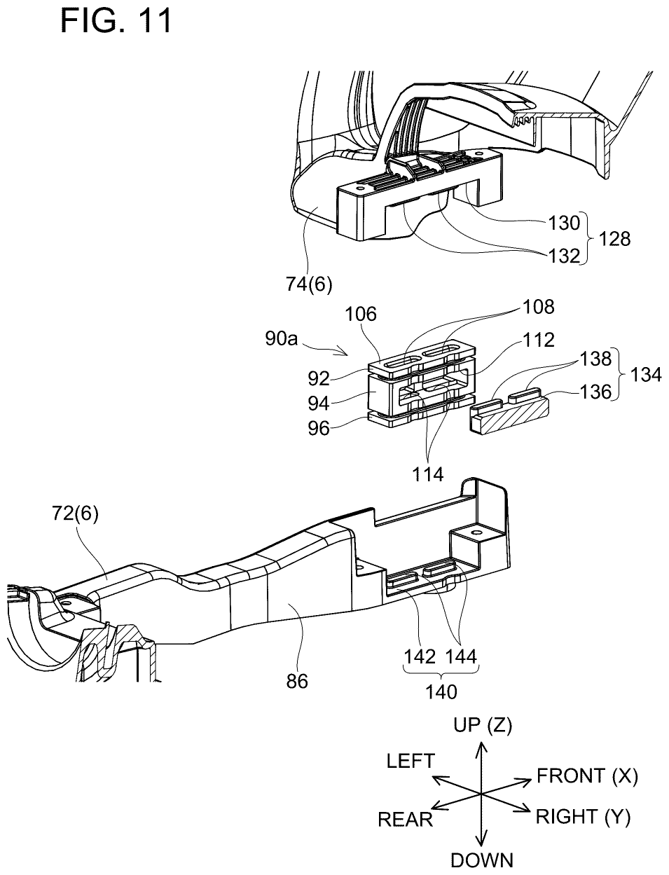

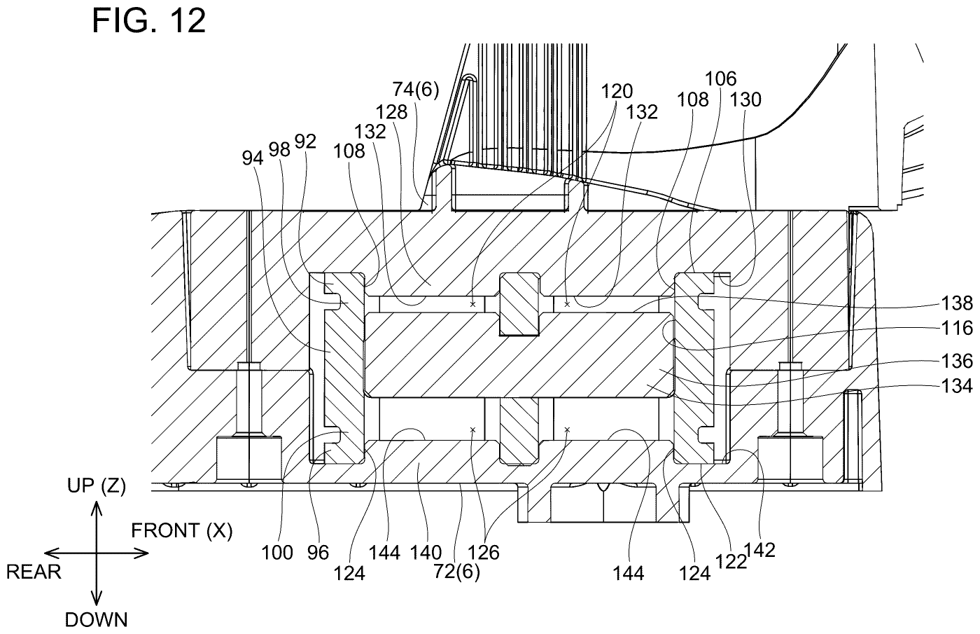

As shown in FIG. 11, the vibration damping member 90a is arranged such that +X direction coincides with the front direction, +Y direction coincides with the right direction, and +Z direction coincides with the up direction. The first mount portion 92 is attached to a first mount element 128 located in a left portion of the handle member 74. The first mount element 128 comprises a support surface 130 oriented downward (in −Z direction) and a plurality of mount projections 132 projecting downward (in −Z direction) from the support surface 130. The mount projections 132 each have a shape configured to fit in the mount holes 108. As shown in FIG. 12, the first mount portion 92 is mounted to the first mount element 128 by fitting the mount projections 132 into the mount holes 108 and bringing the mount surface 106 into contact with the support surface 130. The second mount portion 94 shown in FIG. 11 is mounted to a second mount element 134 located on a left portion of the mechanism housing 26 (see FIG. 6). The second mount element 134 comprises a mount frame 136 projecting leftward (in −Y direction) from the outer surface of the mechanism housing 26 and a plurality of mount projections 138 projecting upward (in +Z direction) from the upper surface of the mount frame 136. The mount frame 136 has a shape configured to fit in the mount recess 112. The mount projections 138 each have a shape configured to fit in the mount holes 116 (see FIG. 9). As shown in FIG. 12, the second mount portion 94 is mounted to the second mount element 134 by fitting the mount frame 136 into the mount recess 112 and fitting the mount projections 138 into the mount holes 116. The third mount portion 96 shown in FIG. 11 is mounted to a third mount element 140 located in the left arm 86. The third mount element 140 comprises a support surface 142 oriented upward (in +Z direction) and a plurality of mount projections 144 projecting upward (in +Z direction) from the support surface 142. The mount projections 144 each have a shape configured to fit in the mount holes 124 (see FIG. 9). As shown in FIG. 12, the third mount portion 96 is mounted to the third mount element 140 by fitting the mount projections 144 into the mount holes 124 and bringing the mount surface 122 into contact with the support surface 142. The vibration damping member 90a is typically held between the base body 72 and the handle member 74 and compressed in the up-down direction (Z direction).

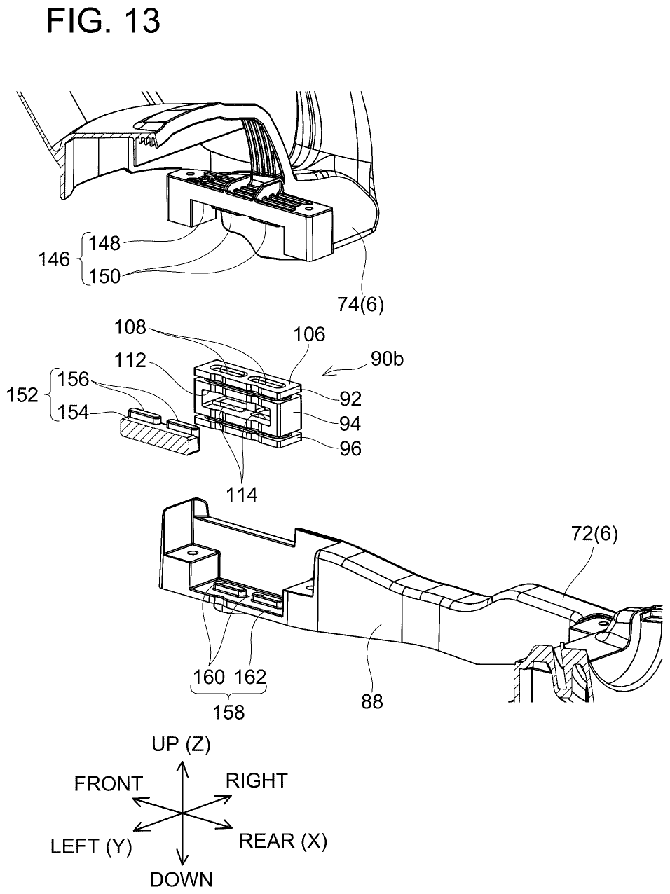

As shown in FIG. 13, the vibration damping member 90b is arranged such that +X direction coincides with the rear direction, +Y direction coincides with the left direction, and +Z direction coincides with the up direction. The first mount portion 92 is mounted to a first mount element 146 located in a right portion of the handle member 74. The first mount element 146 comprises a support surface 148 and a plurality of mount projections 150. The second mount portion 94 is mounted to a second mount element 152 located on a right portion of the mechanism housing 26 (see FIG. 6). The second mount element 152 comprises a mount frame 154 and a plurality of mount projections 156. The third mount portion 96 is mounted to a third mount element 158 located in the right arm 88. The third mount element 158 comprises a support surface 160 and a plurality of mount projections 162. The first mount element 146, the second mount element 152, and the third mount element 158 have substantially the same shapes as those of the above-described first mount element 128, second mount element 134, and third mount element 140, respectively, and thus detailed descriptions for the first mount element 146, the second mount element 152, and the third mount element 158 are omitted. The vibration damping member 90b is typically held between the base body 72 and the handle member 74 and compressed in the up-down direction (Z direction).

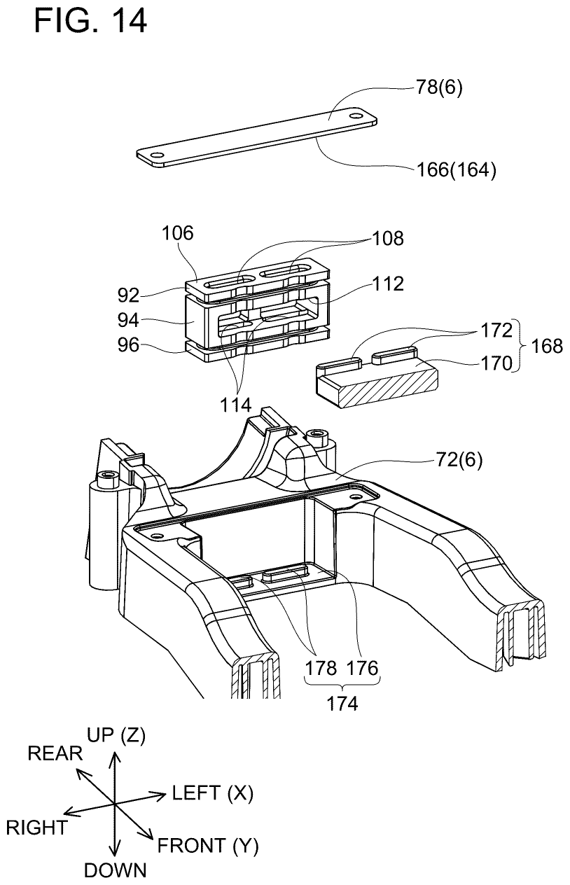

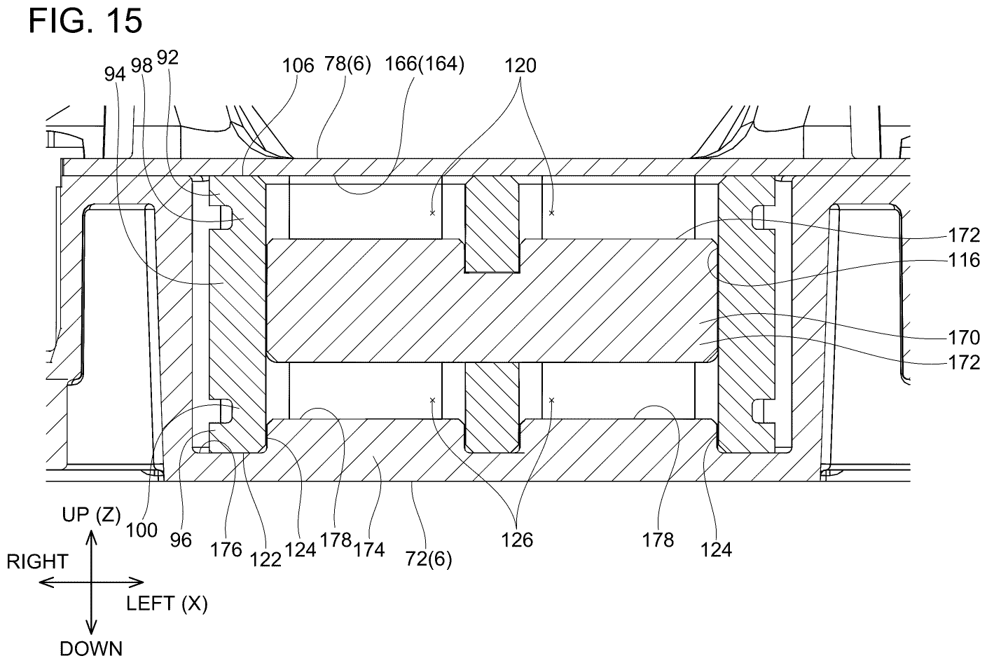

As shown in FIG. 14, the vibration damping member 90c is arranged such that +X direction coincides with the left direction, +Y direction coincides with the front direction, and +Z direction coincides with the up direction. The first mount portion 92 is mounted to a first mount element 164 located on the plate member 78. The first mount element 164 comprises a support surface 166 (i.e., the lower surface of the plate member 78). Unlike the above-described first mount elements 128 and 146, the first mount element 164 does not comprise any projections configured to fit in the mount holes 108 in the first mount portion 92. As shown in FIG. 15, the first mount portion 92 is mounted to the first mount element 164 by bringing the mount surface 106 into contact with the support surface 166. The second mount portion 94 is mounted to a second mount element 168 located on a rear portion of the mechanism housing 26 (see FIG. 6). The second mount element 168 comprises a mount frame 170 and a plurality of mount projections 172. The third mount portion 96 is mounted to a third mount element 174 located in a rear portion of the base body 72. The third mount element 174 comprises a support surface 176 and a plurality of mount projections 178. The second mount element 168 and the third mount element 174 have substantially the same shapes as those of the above-described second mount elements 134, 152 and third mount elements 140, 158, respectively, and thus detailed descriptions for the second mount element 168 and the third mount element 174 are omitted. The vibration damping member 90c is typically held between the base body 72 and the plate member 78 and compressed in the up-down direction (Z direction).

As shown in FIG. 8, a first vibration damping region A1 is a region between the mount surface 106 and a +Z direction wall surface of the mount recess 112 in each of the vibration damping members 90a, 90b, 90c. Vibrations from the first mount elements 128, 146, 164 (see FIG. 6) are transmitted to the second mount elements 134, 152, 168 (see FIG. 6) or vice versa mainly via the first vibration damping regions A1. A second vibration damping region A2 is a region between the mount surface 122 and a-Z direction wall surface of the mount recess 112 in each of the vibration damping members 90a, 90b, 90c. Vibrations from the second mount elements 134, 152, 168 are transmitted to the third mount elements 140, 158, 174 (see FIG. 6) or vice versa mainly via the second vibration damping regions A2.

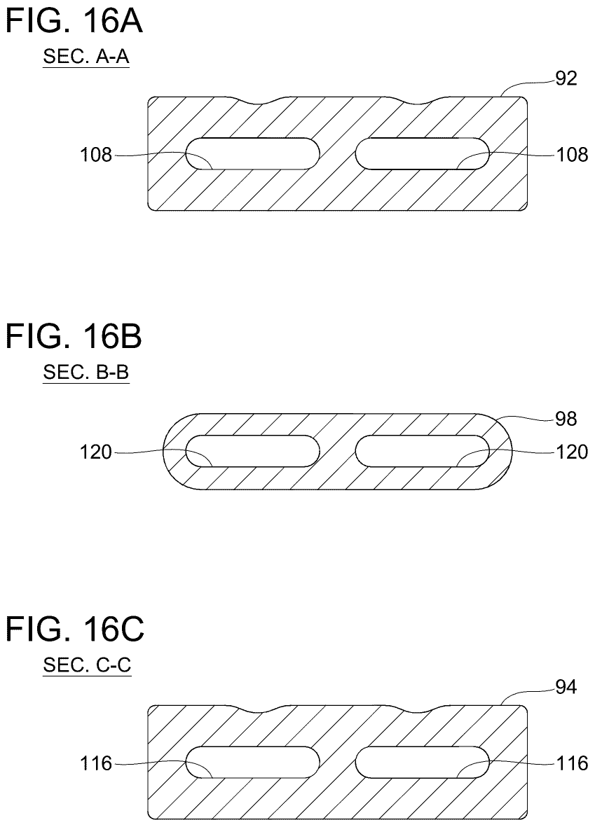

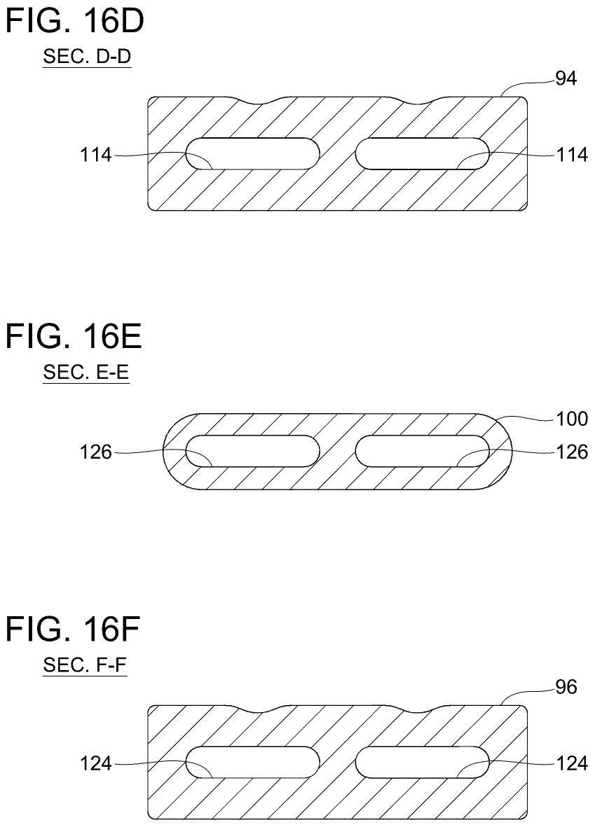

A cross section A-A shown in FIG. 16A is a cross section of a part of the first vibration damping region A1 that corresponds to the first mount portion 92, along a direction orthogonal to Z direction. A cross section B-B shown in FIG. 16B is a cross section of a part of the first vibration damping region A1 that corresponds to the first connection portion 98, along the direction orthogonal to Z direction. A cross-section C-C shown in FIG. 16C is a cross section of a part of the first vibration damping region A1 that corresponds to the second mount portion 94, along the direction orthogonal to Z direction. A cross section D-D shown in FIG. 16D is a cross section of a part of the second vibration damping region A2 that corresponds to the second mount portion 94, along the direction orthogonal to Z direction. A cross-section E-E shown in FIG. 16E is a cross section of a part of the second vibration damping region A2 that corresponds to the second connection portion 100, along the direction orthogonal to Z direction. A cross section F-F shown in FIG. 16F is a cross section of a part of the second vibration damping region A2 that corresponds to the third mount portion 96, along the direction orthogonal to Z direction. In this embodiment, a magnitude relationship Sa=Sc=Sd=Sf>Sb=Se holds true, where Sa is the area of the cross section A-A, Sb is the area of the cross section B-B, Sc is the area of the cross section C-C, Sd is the area of the cross section D-D, Se is the area of the cross section E-E, and Sf is the arear of the cross section F-F. This magnitude relationship can be regarded as a magnitude relationship between shear rigidities of the cross sections. Thus, within the first vibration damping region A1, the first connection portion 98 is more likely to undergo shear deformation in X and Y directions than the first mount portion 92 and the second mount portion 94, and within the second vibration damping region A2, the second connection portion 100 is more likely to undergo shear deformation in X and Y directions than the second mount portion 94 and the third mount portion 96.

When the pair of shear blades 16 shown in FIG. 6 is driven, the working unit 4 vibrates in the front-rear direction (in X direction of the vibration damping members 90a, 90b, in Y direction of the vibration damping member 90c) due to the reciprocation of the shear blades 16. In this case, the vibrations of the working unit 4 are transmitted, via the second mount elements 134, 152, 168, the first vibration damping regions A1 of the vibration damping members 90a, 90b, 90c (see FIG. 8), and the first mount elements 128, 146, 164 in this order, to the base 6. The vibrations of the working unit 4 are also transmitted, via the second mount elements 134, 152, 168, the second vibration damping regions A2 of the vibration damping members 90a, 90b, 90c (see FIG. 8), and the third mount elements 140, 158, 174 in this order, to the base 6. In the course of the vibration transmission, the first connection portions 98 within the first vibration damping regions A1 of the vibration damping members 90a, 90b 90c undergo large shear deformation in the front-rear direction and the second connection portions 100 within the second vibration damping regions A2 of the vibration damping members 90a, 90b, 90c also undergo large shear deformation in the front-rear direction, which reduces the vibrations to the base 6. Since the vibration damping member 90c and the first mount element 164 are not restricted with a recess and a projection, a force (i.e., vibrations) is transmitted therebetween only by the mount surface 106 and the support surface 166 rubbing against each other. Thus, it can be construed that vibration isolation is provided between the vibration damping member 90c and the first mount element 164.

### Cooling Configuration of Hedge Trimmer 2

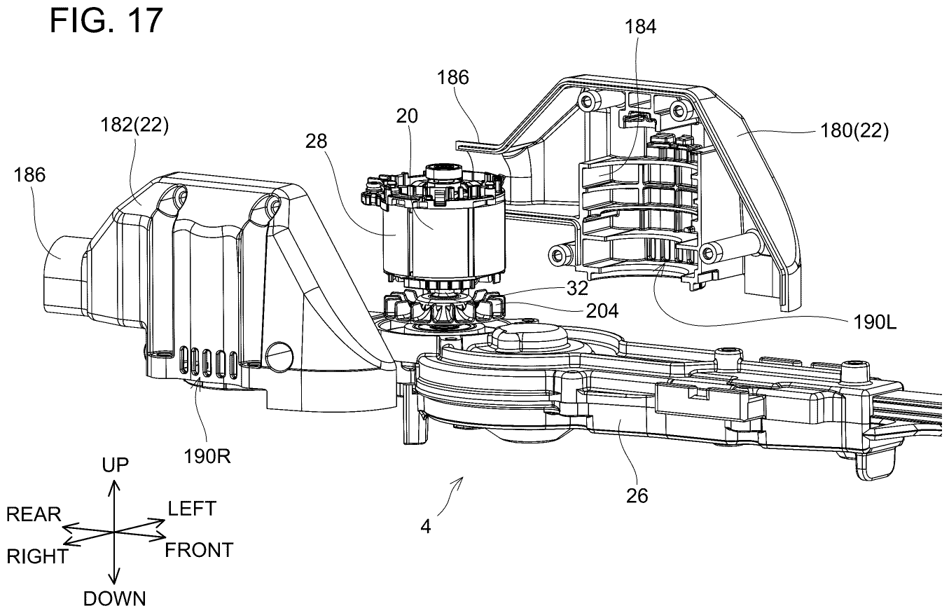

As shown in FIG. 17, the motor housing 22 is constituted of a left housing member 180 and a right housing member 182. The left housing member 180 and the right housing member 182 are fixed to each other with screws (not shown). A motor supporting frame 184 is formed on the inner wall of the motor housing 22. The motor supporting frame 184 is in contact with the outer surface of the stator 28 to support the electric motor 20. The motor supporting frame 184 is divided to a portion formed on the left housing member 180 and a portion formed on the right housing member 182 (not shown). When the motor housing 22 is removed, the outer surface of the stator 28 is exposed to the outside of the hedge trimmer 2.

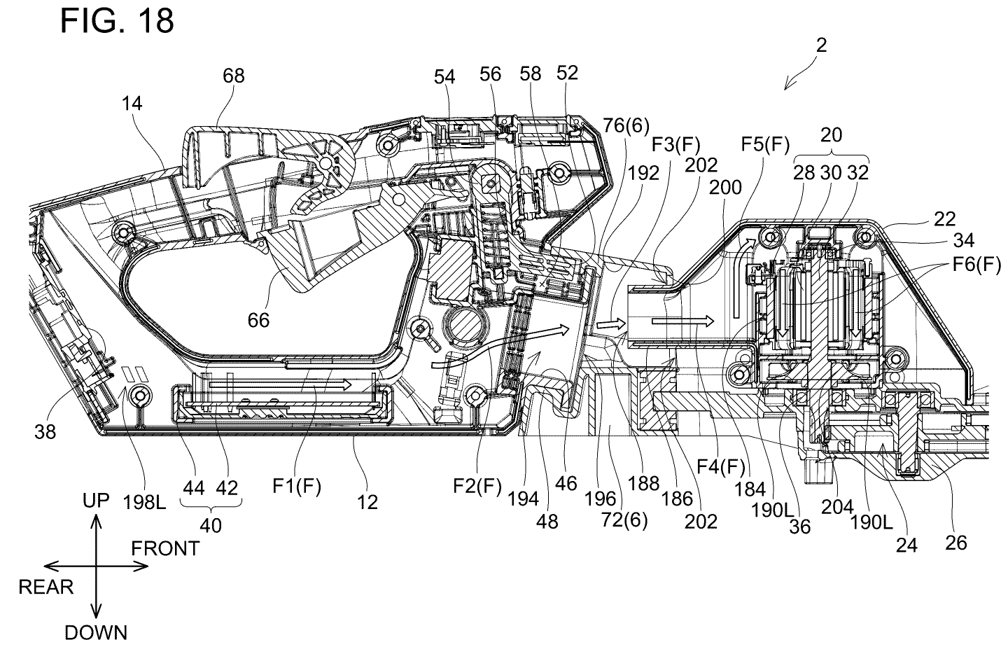

As shown in FIG. 18, the motor housing 22 comprises a duct 186 extending rearward from a position located rearward of the electric motor 20, an air inlet 188 defined at the rear end of the duct 186, an air outlet 190L defined in the left surface of the motor housing 22, and an air outlet 190R (see FIG. 17) defined in the right surface of the motor housing 22. The air inlet 188 is open to the inside of a passage 192 defined in the base 6. The air outlets 190R, 190L are both open to the outside of the hedge trimmer 2.

The rear housing 12 comprises a through hole 194 that extends through the shaft portion 46 to communicate the inside of the rear housing 12 with the outside thereof, an air outlet 196 which is the front opening of the through hole 194, an air inlet 198L defined in the left surface of the rear housing 12, and an air inlet 198R (see FIG. 1) defined in the right surface of the rear housing 12. The air outlet 196 is open to the inside of the passage 192 defined in the base 6. The air inlets 198L, 198R are both open to the outside of the hedge trimmer 2.

The passage 192 is located forward of the shaft holding portion 48. The passage 192 and the shaft holding portion 48 are partially in the base body 72 and partially in the semicylindrical member 76. An opening 200 is defined at the front end of the passage 192 and the duct 186 of the motor housing 22 is inserted to the opening 200. There is a clearance 202 between the outer surface of the duct 186 and the periphery of the opening 200. Without the clearance 202, the motor housing 22 would contact the semicylindrical member 76, which results in direct vibration transmission from the working unit 4 to the base 6. The clearance 202 prevents the motor housing 22 from contacting the semicylindrical member 76, thereby preventing direct vibration transmission from the working unit 4 to the base 6. The clearance 202 is closed by a dust blocking member (not shown). A material that barely transmits vibrations (e.g., sponge) is used for the dust blocking member. This prevents foreign particles such as dust from entering the hedge trimmer 2 through the clearance 202.

The hedge trimmer 2 comprises a cooling air passage F extending from the air inlets 198L, 198R in the rear housing 12 to the air outlets 190R, 190L in the motor housing 22 via the inside of the rear housing 12, the air outlet 196 in the rear housing 12, the inside of the passage 192, the air inlet 188 in the motor housing 22, and the inside of the motor housing 22. In this embodiment, a fan 204 is fixed to the output shaft 32 and the fan 204 generates an air flow (which may be simply termed cooling air) along the cooling air passage F. The fan 204 is located below the rotor 30 and overlaps the air outlets 190R, 190L when viewed in the right-left direction. When the electric motor 20 operates, the fan 204 rotates with the output shaft 32, thereby generating the cooling air in the cooling air passage F.

The cooling air passage F comprises a first passage section F1 in which air flows from the air inlets 198L, 198R to a lower front portion of the rear housing 12, a second passage section F2 in which the air flows from the lower front portion of the rear housing 12 via the through hole 194 to the air outlet 196, a third passage section F3 in which the air flows from the air outlet 196 via the inside of the passage 192 to the air inlet 188, a fourth passage section F4 in which the air flows from the air inlet 188 forward via the inside of the duct 186, a fifth passage section F5 in which the air flows along the rear surface of the motor supporting frame 184 to an upper portion of the motor housing 22, and a sixth passage section F6 in which the air flows from the upper portion of the motor housing 22 via spacing between the stator 28 and the rotor 30 of the electric motor 20 to the air outlets 190R, 190L.

The control unit 40 is located in the first passage section F1. The first passage section F1 extends along the longitudinal direction of the control unit 40 (i.e., the front-rear direction). The air inlets 198L, 198R of the rear housing 12 are located rearward of the rear end of the control unit 40. Thus, the control unit 40 can be cooled from the rear end over to the front end by the cooling air flowing in the first passage section F1.

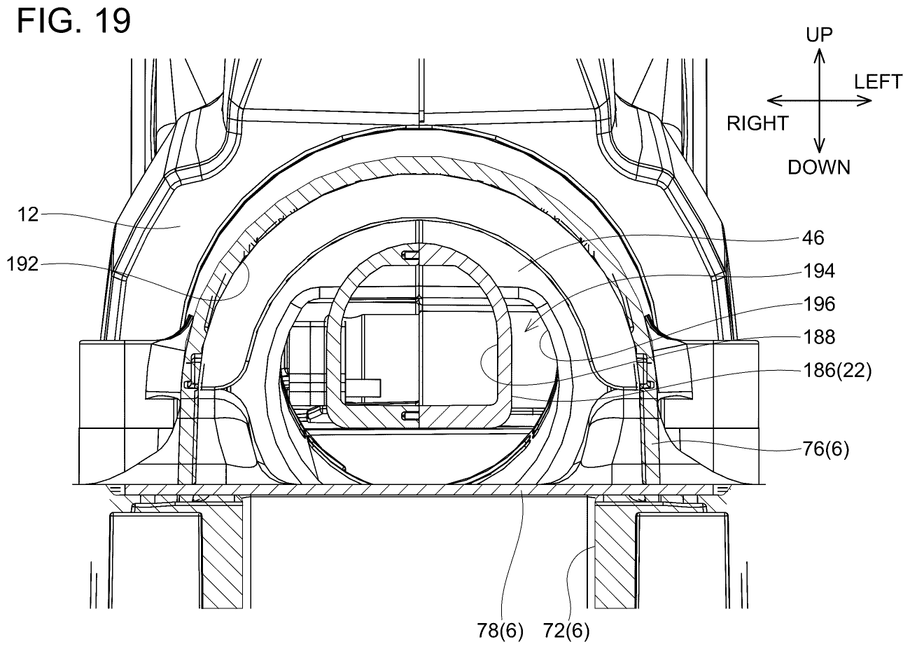

As shown in FIG. 19, as the inside of the passage 192 is viewed in the front-rear direction, the air inlet 188 of the motor housing 22 and the air outlet 196 of the rear housing 12 overlap each other. This allows the cooling air to smoothly flows in the third passage section F3.

Electric wires electrically connecting electric components housed in the rear housing 12 to electric components housed in the motor housing 22 are located in the cooling air passage F, although this is not shown. For example, an electric wire electrically connecting the control unit 40 housed in the rear housing 12 to the electric motor 20 housed in the motor housing 22 is located in the cooling air passage F.

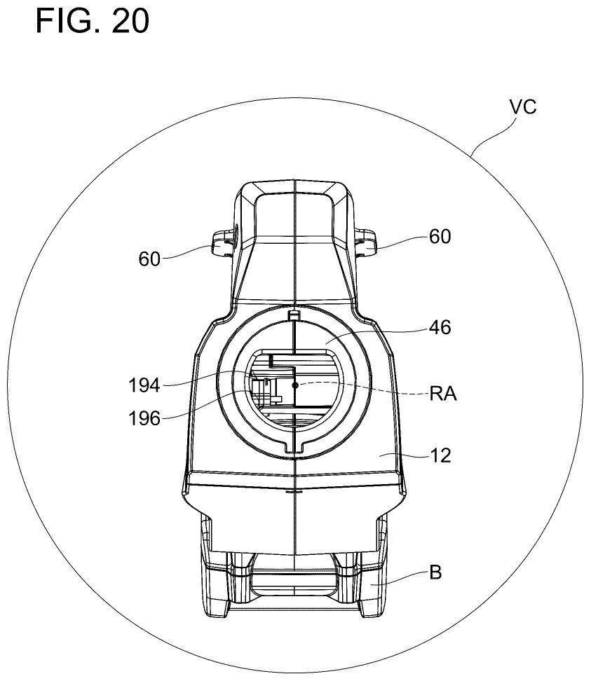

FIG. 20 shows the rear housing 12, the battery pack B attached to the battery receptacle 38 of the rear housing 12, and an imaginary circle VC with the rotation axis RA defining the center of the circle. The radius of the imaginary circle VC is for example in the range from 5 cm to 15 cm, and it is 13 cm in this embodiment. As viewed in the direction of the rotation axis RA, the rear housing 12 and the battery pack B are located within the imaginary circle VC.

As shown in FIG. 2, a center of gravity BG of the battery pack B attached to the battery receptacle 38 is located rearward of a rear end 14r of the rear handle 14. A center of gravity HG of the hedge trimmer 2 is located rearward of a rear end 8r of the front handle 8 and forward of a front end 14f of the rear handle 14. Further, the center of gravity HG of the hedge trimmer 2 is located within the motor housing 22. It should be noted that the center of gravity HG herein means the center of gravity of the hedge trimmer 2 in which the battery pack B is attached to the battery receptacle 38 and the rear housing 12 is in the normal position. Even when the rear housing 12 is in the rotated position, the center of gravity of the hedge trimmer 2 in which the battery pack B is attached to the battery receptacle 38 is located rearward of the rear end 8r of the front handle 8 and forward of the front end 14f of the rear handle 14, although this is not shown.

### Variants

The working machine may be a working machine other than the hedge trimmer 2 (e.g., a reciprocating saw, a chainsaw, a grass trimmer). In this case, the working unit 4 may comprise, instead of the pair of shear blades 16, another working mechanism (e.g., a saw, a saw chain, a rotary blade).

The hedge trimmer 2 may reciprocate only one of the shear blades 16 instead of reciprocating both of the shear blades 16.

The prime mover configured to drive the pair of shear blades 16 may be a prime mover other than the electric motor 20 (e.g., an engine with a combustion mechanism).

Instead of the battery receptacle 38, a power cable for connection to an external power supply (e.g., a commercial power supply or a backpack-type power supply) may be located on the rear housing 12. In this case, the hedge trimmer 2 may operate with electric power supplied through the power cable from the external power supply.

The electric motor 20 may be a motor other than the inner rotor brushless motor (e.g., an outer rotor brushless motor, a brush motor, or the like).

The base 6 may house the motor housing 22 and the mechanism housing 26. In this case, the motor housing 22 and the mechanism housing 26 may be invisible when the hedge trimmer 2 is viewed from the outside.

(See FIG. 6.) The base 6 may not comprise the left support 80 nor the left arm 86. In this case, the base 6 may support the working unit 4 by the right support 82 via the vibration damping member 90b and by the rear support 84 via the vibration damping member 90c. Alternatively, the base 6 may not comprise the right support 82 nor the right arm 88. In this case, the base 6 may support the working unit 4 by the left support 80 via the vibration damping member 90a and by the rear support 84 via the vibration damping member 90c.

(See FIG. 18.) The control unit 40 may not be located in the first passage section F1. For example, the control unit 40 may be located in the second passage section F2. In this case, the longitudinal direction of the control unit 40 may be along the up-down direction. Alternatively, the control unit 40 may not be located in the cooling air passage F. For example, the control unit 40 may be located forward of the battery receptacle 38 to face the battery receptacle 38.

(See FIG. 3.) The rear housing 12 may be attached to the base 6 such that it cannot rotate. In this case, the hedge trimmer 2 may not comprise elements such as the rotation locking member 54, the plurality of engagement grooves 52, the receiving groove 58, etc.

(See FIG. 17.) A member that covers the electric motor 20 (e.g., a cylindrical cover extending along the outer surface of the stator 28) may be provided between the motor housing 22 and the electric motor 20. In this case, the outer surface of the stator 28 may not be exposed to the outside of the hedge trimmer 2 even whether motor housing 22 is removed.

(See FIG. 2.) The shape of the rear portion of the rear housing 12 and the position and shape of the battery receptacle 38 may be varied. In this case, the sliding direction SD of the battery pack B may be different from the direction described in connection with the embodiment. For example, the sliding direction SD may be an upward direction, a rightward direction, or a forward direction.

(See FIG. 20.) When viewed in the direction of the rotation axis RA, at least a part of the rear housing 12 and/or at least a part of the battery pack B may be located outside the imaginary circle VC.

(See FIG. 2.) The center of gravity BG of the battery pack B attached to the battery receptacle 38 may be located forward of the rear end 14r of the rear handle 14.

(See FIG. 2.) The center of gravity HG of the hedge trimmer 2 may be located forward of the rear end 8r of the front handle 8. Alternatively, the center of gravity HG of the hedge trimmer 2 may be located rearward of the front end 14f of the rear handle 14.

(See FIG. 6.) Since the vibration damping members 90a, 90b, 90c each are symmetric in Z direction, the first mount portions 92 may be mounted to the third mount elements 140, 158, 174 and the third mount portions 96 may be mounted to the first mount elements 128, 146, 164. In this case, the second mount portions 94 may be mounted to the second mount elements 134, 152, 168 by fitting the plurality of projections 138, 156, 172 into the plurality of mount holes 114.

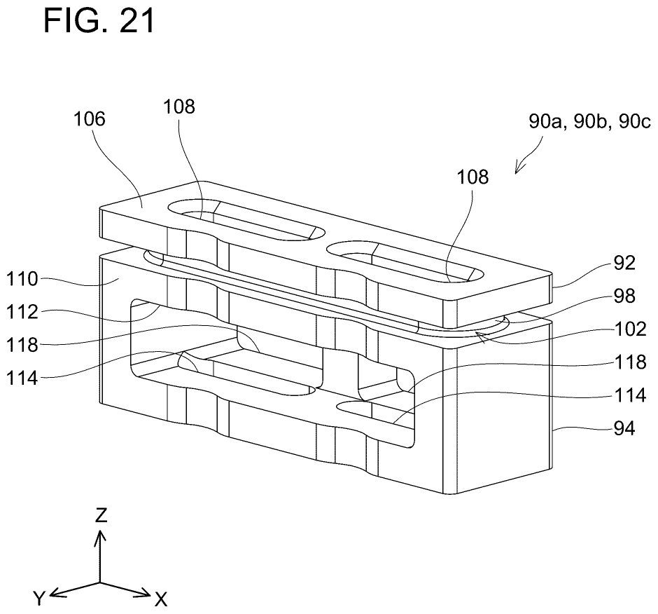

As shown in FIG. 21, each of the vibration damping members 90a, 90b, 90c may not comprise the third mount portion 96 nor the second connection portion 100. Even without them, the base 6 can hold the working unit 4 by mounting the first mount portions 92 to the third mount elements 140, 158, 174 and mounting the second mount portions 94 to the second mount elements 134, 152, 168. In this case, when the working unit 4 vibrates, the first connection portions 98 undergo relatively large shear deformation, which reduces vibrations from the second mount portions 94 to the first mount portions 92 via the first connection portions 98. Thus, vibrations from the working unit 4 to the front handle 8 on the base 6 can be reduced.

(See FIG. 7.) The shape of the vibration damping members 90a, 90b, 90c is not limited to the cuboid shape. The vibration damping members 90a, 90b, 90c may have for example a substantially cylindrical shape whose height direction is different from Z direction.

(See FIG. 10.) The hollow space 120 may not be defined in each first connection portion 98. That is, each first connection portion 98 may be solid. The hollow space 126 may not be defined in each second connection portion 100. That is, each second connection portion 100 may be solid.

(See FIG. 7.) Each second mount portion 94 may not comprise the plurality of lightening holes 118.

(See FIG. 7.) The shape of the first mount portions 92 (the third mount portions 96) may be varied. For example, each of the first mount portions 92 (the third mount portions 96) may comprise a projection projecting from the mount surface 106 (the mount surface 122) in +Z direction (in-Z direction), instead of the plurality of mount holes 108 (the plurality of mount holes 124). The shape of the first mount elements 128, 146, 164 (the third mount elements 140, 158, 174) may also be varied corresponding to the shape of the first mount portions 92 (the third mount portions 96). For example, if each first mount portion 92 (each third mount portion 96) comprises the projection, each of the first mount elements 128, 146, 164 (the third mount elements 140, 158, 174) may comprise a hole or recess configured to receive the projection.

(See FIG. 7.) The shape of the second mount portions 94 may be varied. For example, each second mount portion 94 may not comprise the plurality of mount holes 114 or the plurality of mount holes 116. The second mount elements 134, 152, 168 may not comprise the plurality of mount projections 138, 156, 172.

(See FIG. 10.) The plurality of mount holes 108 and the hollow spaces 120, the hollow spaces 120 and the plurality of mount holes 116, the plurality of mount holes 124 and the hollow spaces 126, or the hollow spaces 126 and the plurality of mount holes 114 may not be spatially connected.

### Features of First Embodiment

As described above, in one or more embodiments, the hedge trimmer 2 (an example of working machine) comprises the working unit 4 including the pair of shear blades 16 (an example of working mechanism), the electric motor 20 configured to drive the pair of shear blades 16, and the motor housing 22 that houses the electric motor 20, the control unit 40 configured to control the electric motor 20, the base 6 supporting the working unit 4, the rear housing 12 attached to the rear portion of the base 6, the front handle 8 located on the base 6 and configured to be grasped by the user with one hand of the user, and the rear handle 14 located on the rear housing 12 and configured to be grasped by the user with the other hand of the user. The base 6 comprises the passage 192. The motor housing 22 comprises the air inlet 188 (an example of inner air inlet) that opens to the inside of the passage 192 and the air outlets 190R, 190L (an example of outer air outlet) that open to the outside of the hedge trimmer 2. The rear housing 12 comprises the air inlets 198L, 198R (an example of outer air inlet) that opens to the outside of the hedge trimmer 2 and the air outlet 196 (an example of inner air outlet) that opens to the inside of the passage 192. The cooling air passage F is defined to extend from the air inlets 198L, 198R to the air outlets 190R, 190L via the inside of the rear housing 12, the air outlet 196, the inside of the passage 192, the air inlet 188, and the inside of the motor housing 22. As viewed along the front-rear direction, the air inlet 188 and the air outlet 196 overlap each other.

If the air inlet 188 and the air outlet 196 do not overlap each other as viewed along the front-rear direction, air flowing out of the air outlet 196 may not smoothly flow into the air inlet 188. This may lead to an insufficient amount of cooling air and thus may result in insufficient cooling for the electric motor 20. Since the air inlet 188 and the air outlet 196 overlap each other as viewed along the front-rear direction in the configuration above, air flowing out of the air outlet 196 smoothly flows into the air inlet 188. This increases the amount of cooling air, and thus the electric motor 20 can thereby be sufficiently cooled. Further, since the air inlets 198L, 198R, which open to the outside of the hedge trimmer 2, are defined in the rear housing 12 located far from the pair of shear blades 16 in the above configuration, foreign matters dispersed due to the operation of the shear blades 16 are prevented from entering the hedge trimmer 2.

In one or more embodiments, the control unit 40 is housed in the rear housing 12 and located in the cooling air passage F.

The configuration above allows not only the electric motor 20 but also the control unit 40 to be cooled by cooling air.

In one or more embodiments, the cooling air passage F comprises the first passage section F1 defined in the rear housing 12 and extending in the front-rear direction. The control unit 40 is located in the first passage section F1 such that the longitudinal direction of the control unit 40 is along the front-rear direction.

The configuration above allows the control unit 40 to be efficiently cooled since the cooling air flows along the longitudinal direction of the control unit 40.

In one or more embodiments, the rear housing 12 is attached to the base 6 such that the rear housing 12 is rotatable about the rotation axis RA. The rear housing 12 is movable relative to the base 6 between the normal position and the rotated position in which the rear housing 12 has been rotated about the rotation axis RA from the normal position.

The configuration above allows the user to change the position of the rear housing 12 relative to the base 6 to change the positional relationship between the front handle 8 and the rear handle 14. For example, the user can change the positional relationship between the front handle 8 and the rear handle 14 to hold the hedge trimmer 2 in a comfortable posture.

In one or more embodiments, the rear housing 12 comprises the shaft portion 46 extending along the rotation axis RA. The base 6 comprises the shaft holding portion 48 that holds the shaft portion 46 such that the shaft portion 46 is rotatable about the rotation axis RA. The shaft portion 46 comprises the through hole 194 that extends through the shaft portion 46 to communicate the inside of the rear housing 12 with the outside of the rear housing 12. The opening of the through hole 194 that is directed toward the outside of the rear housing 12 functions as the air outlet 196.

If the air outlet 196 is located far from the rotation axis RA, the positional relationship between the air inlet 188 and the air outlet 196 is significantly changed when the rear housing 12 is rotated relative to the base 6. Thus, depending on the position of the rear housing 12 relative to the base 6, the air flowing out of the air outlet 196 may not smoothly flow into the air inlet 188. In the configuration above, the air outlet 196 is located near the rotation axis RA since the air outlet 196 is defined in the shaft portion 46. Therefore, the positional relationship between the air inlet 188 and the air outlet 196 is not changed much even when the rear housing 12 is rotated relative to the base 6. Thus, the configuration above can smoothly guide the air flowing out of the air outlet 196 into the air inlet 188, regardless of the position of the rear housing 12 relative to the base 6.

In one or more embodiments, the electric motor 20 is an inner rotor brushless motor comprising the stator 28, the rotor 30 located inward of the stator 28, and the output shaft 32 fixed to the rotor 30. When the motor housing 22 is removed from the hedge trimmer 2, the outer surface of the stator 28 is exposed to the outside of the hedge trimmer 2.

If the outer surface of the stator 28 is covered by a member different from the motor housing 22, heat may not be released from the stator 28 (i.e., the electric motor 20). The configuration above allows release of heat from the electric motor 20 since the motor housing 22 is the only member that covers the outer surface of the stator 28.

In one or more embodiments, the working mechanism comprises the pair of shear blades 16 (an example of a pair of blades) extending in the front-rear direction. The blades 16 are configured to reciprocate relative to each other in the front-rear direction when driven by the electric motor 20.

The configuration above prevents foreign matters dispersed due to the operation of the pair of shear blades 16 from entering the inside of the hedge trimmer 2, while sufficiently cooling the electric motor 20.

In one or more embodiments, the hedge trimmer 2 (an example of working machine) comprises the electric motor 20, the pair of shear blades 16 (an example of working mechanism) configured to be driven by the electric motor 20, the base 6 supporting the pair of shear blades 16, the rear housing 12 that is attached to the rear portion of the base 6 such that the rear housing 12 is rotatable about the predetermined rotation axis RA and is movable relative to the base 6 between the normal position and the rotated position in which the rear housing 12 has been rotated about the rotation axis RA from the normal position, the front handle 8 located on the base 6 and configured to be grasped by the user with one hand of the user, the rear handle 14 located on the rear housing 12 and configured to be grasped by the user with the other hand of the user, and the battery receptacle 38 located in the rear housing 12 and to which the battery pack B is detachably attached. In the state where the battery pack B is attached to the battery receptacle 38, the battery pack B is located on the rotation axis RA.

In the configuration above, the battery pack B is attached to the rear housing 12 such that it is located on the rotation axis RA. Thus, a moment of inertia of the battery pack B about the rotation axis RA is relatively small. Therefore, the user can rotate the rear housing 12 together with the battery pack B with a relatively small force. Thus, the usability of the hedge trimmer 2 is improved.

In one or more embodiments, in the state where the rear housing 12 is in the normal position, the battery receptacle 38 is located in the rear portion of the rear housing 12.

When gripping the front handle 8 and the rear handle 14, the user can easily handle the hedge trimmer 2 with the center of gravity HG of the hedge trimmer 2 located near the user's body. However, the center of gravity HG of the hedge trimmer 2 tends to be located closer to the base 6 supporting the pair of shear blades 16 (i.e., the front portion of the hedge trimmer 2) relative to the body of user gripping the front handle 8 and the rear handle 14. Since the battery pack B is attached to the rear portion of the rear housing 12 in the configuration above, the weight of the battery pack B allows the center of gravity HG of the hedge trimmer 2 to be located closer to the rear housing 12 (i.e., the rear portion of the hedge trimmer 2). Thus, the center of gravity HG of the hedge trimmer 2 is located closer to the body of the user gripping the front handle 8 and the rear handle 14. This allows the user to easily handle the hedge trimmer 2.

In one or more embodiments, in the state where the rear housing 12 is in the normal position and the battery pack B is attached to the battery receptacle 38, the center of gravity BG of the battery pack B is located rearward of the rear end 14r of the rear handle 14.

In the configuration above, the center of gravity BG of the battery pack B is located rearward of the user's hand gripping the rear handle 14, regardless of which part of the rear handle 14 the user grips. That is, the center of gravity BG of the battery pack B is located rearward of the user's body. This allows the center of gravity HG of the hedge trimmer 2 to be located closer to the user's body.

In one or more embodiments, in the state where the rear housing 12 is in the normal position, the rear handle 14 is located on the upper portion of the rear housing 12 and extends in the front-rear direction. In the state where the rear housing 12 is in the normal position, the battery pack B is attached to the battery receptacle 38 by being slid relative to the battery receptacle 38 in the sliding direction SD from the upper rear end of the battery receptacle 38 toward the lower front end of the battery receptacle 38.

The upper portion of the rear housing 12 on which the rear handle 14 configured to be gripped by the user is located needs to have a certain length in the front-rear direction. The lower portion of the rear housing 12 on which the rear handle 14 is not located, however, may have a short length in the front-rear direction. In the configuration above, the battery receptacle 38 located in the rear portion of the rear housing 12 has a slanted shape with its lower end located forward of its upper end. Thus, in the front-rear direction, the upper portion of the rear housing 12 can have a certain length and the lower portion of the rear housing 12 can have a relatively short length.

In one or more embodiments, in the state where the rear housing 12 is in the normal position and the battery pack B is attached to the battery receptacle 38, the center of gravity HG of the hedge trimmer 2 is located rearward of the rear end 8r of the front handle 8 and forward of the front end 14f of the rear handle 14.

When the center of gravity HG of the hedge trimmer 2 is located between the front handle 8 and the rear handle 14, the center of gravity HG of the hedge trimmer 2 is close to the body of the user gripping the front handle 8 and the rear handle 14. This allows the user to easily handle the hedge trimmer 2.

In one or more embodiments, as viewed along the direction of the rotation axis RA, the rear housing 12 and the battery pack B attached to the battery receptacle 38 are located within the imaginary circle VC with the radius of 13 cm about the rotation axis RA.

In the configuration above, the moments of inertia of the rear housing 12 and the battery pack B about the rotation axis are small. Therefore, the user can rotate the rear housing 12 together with the battery pack B with a small force. Thus, the usability of the hedge trimmer 2 is improved.

In one or more embodiments, the base 6 comprises the left support 80 and/or the right support 82 (an example of front support) supporting the pair of shear blades 16, the rear support 84 supporting the pair of shear blades 16 and located rearward of the left support 80 and/or the right support 82, and the left arm 86 and/or the right arm 88 (an example of arm) extending on side(s) of the pair of blades 16 and connecting the left support 80 and/or the right support 82 to the rear support 84.

In the configuration above, the base 6 is compact and thus is less likely to interfere with the user's body and an object while the user is using the hedge trimmer 2. Thus, the usability of the hedge trimmer 2 is improved.

In one or more embodiments, the arm comprises the left arm 86 extending on the left side of the pair of shear blades 16 and connecting the left support 80 to the rear support 84, and the right arm 88 extending on the right side of the pair of shear blades 16 and connecting the right support 82 to the rear support 84.

If a single arm connects the left support 80 and/or the right support 82 to the rear support 84, the arm may be deteriorated when large stress is applied thereto during use of the hedge trimmer 2 by the user. Since the left arm 86 and the right arm 88 connect the left support 80 and the right support 82 to the rear support 84 in the configuration above, stress is distributed to the left arm 86 and the right arm 88. This prevents the left arm 86 and the right arm 88 from individually receiving large stress and thus suppresses the deterioration of the left arm 86 and right arm 88.

In one or more embodiments, the working mechanism comprises the pair of shear blades 16 (an example of a pair of blades) extending in the front-rear direction. The blades 16 are configured to reciprocate relative to each other in the front-rear direction when driven by the electric motor 20.

In the configuration above, the pair of shear blades 16 is located to be forward of the front handle 8 and extend forward. In this case, the center of gravity HG of the hedge trimmer 2 is more likely to be located closer to the base 6 (i.e., the front portion of the hedge trimmer 2). Since the battery pack B is attached to the rear portion of the rear housing 12 in the configuration above, the weight of the battery pack B allows the center of gravity HG of the hedge trimmer 2 to be located closer to the rear housing 12 (i.e., the rear portion of the hedge trimmer 2). Thus, the center of gravity HG of the hedge trimmer 2 is located closer to the body of the user gripping the front handle 8 and the rear handle 14. This allows the user to easily handle the hedge trimmer 2.

### Second Embodiment: Hedge Trimmer 302

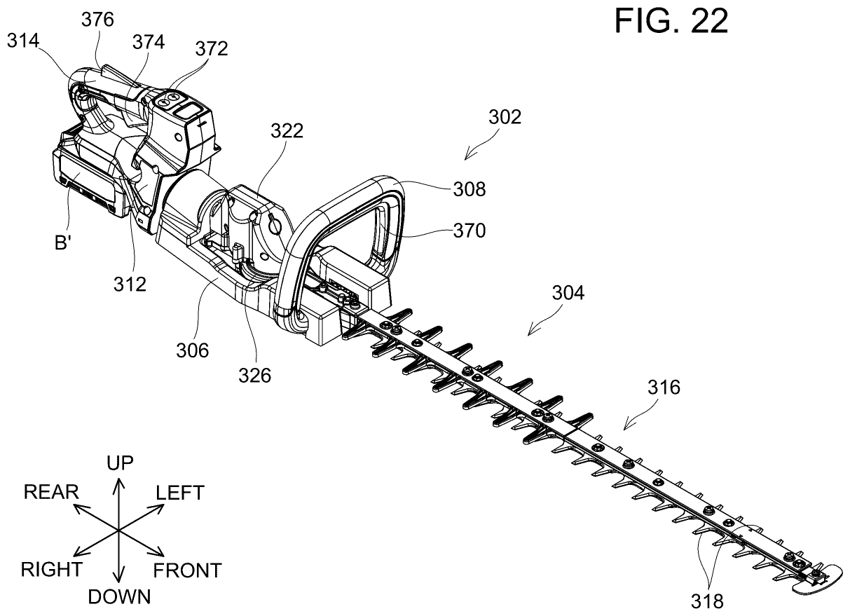

As shown in FIG. 22, a working machine according to this embodiment is a hedge trimmer 302. The hedge trimmer 302 is a gardening tool used mainly to prune hedges and plants. The hedge trimmer 302 comprises a working unit 304, a base 306 configured to support the working unit 304, a front handle 308 located on the base 306, a rear housing 312 attached to a rear portion of the base 306, and a rear handle 314 located on the rear housing 312.

The working unit 304 comprises a pair of shear blades 316. The pair of shear blades 316 extends linearly and comprises a plurality of cutting edges 318 along their longitudinal direction. The shear blades 316 reciprocate with each other to prune hedges and plants with the cutting edges 318. In this embodiment, regarding the longitudinal direction of the pair of shear blades 316, the direction from the base 306 toward the pair of shear blades 316 is termed a front direction and the direction from the pair of shear blades 316 toward the base 306 is termed a rear direction. Further, a direction that is orthogonal to the front-rear direction and parallel to a plane on which the cutting edges 318 of the pair of shear blades 316 lie is termed a right-left direction. Furthermore, regarding the direction orthogonal to the front-rear direction and the right-left direction, the direction from the pair of shear blades 316 toward the front handle 308 is termed an up direction and the direction from the front handle 308 toward the pair of shear blades 316 is termed a down direction.

The front handle 308 is located on a front portion of the base 306 and has a substantially inverted U-shape. The front handle 308 extends above and on the right and left sides of the base 306. The outer surface of the front handle 308 has a substantially cylindrical shape. The rear handle 314 is located on an upper portion of the rear housing 312 and extends linearly along the front-rear direction. The outer surface of the rear handle 314 has a substantially cylindrical shape. The user grasps the front handle 308 with one hand and the rear handle 314 with the other hand to carry the hedge trimmer 302.

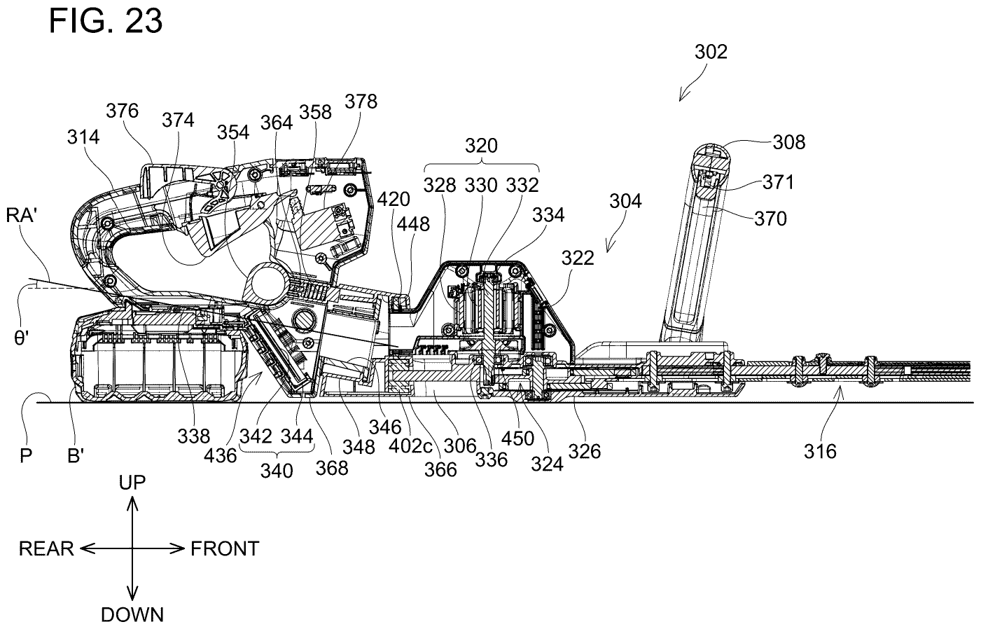

As shown in FIG. 23, the working unit 304 further comprises an electric motor 320, a motor housing 322, a power transmission mechanism 324, and a mechanism housing 326. The electric motor 320 is an inner rotor brushless motor comprising, for example, a stator 328, a rotor 330 disposed inward of the stator 328, and an output shaft 332 fixed to the rotor 330. The electric motor 320 is housed in the motor housing 322. The motor housing 322 is fixed to an upper portion of the mechanism housing 326. The output shaft 332 of the electric motor 320 is rotatably held by the motor housing 322 via a bearing 334 and also rotatably held by the mechanism housing 326 via a bearing 336. The output shaft 332 extends in the up-down direction, and a part thereof is in the motor housing 322 and another part thereof is in the mechanism housing 326. The mechanism housing 326 houses the power transmission mechanism 324 and supports the pair of shear blades 316. The output shaft 332 of the electric motor 320 is coupled to the pair of shear blades 316 via the power transmission mechanism 324. The power transmission mechanism 324 is for example a crank/cam mechanism and converts the rotation of the output shaft 332 to the reciprocation of each shear blade 316. The reciprocation direction of the shear blades 316 is along the front-rear direction.

A battery receptacle 338 to which a battery pack B′ is removably attached is located in a lower rear portion of the rear housing 312. To attach the battery pack B′ to the battery receptacle 338, the battery pack B′ is slid relative to the battery receptacle 338 in the front direction.

A control unit 340 configured to control units/parts of the hedge trimmer 302 is housed in a lower front portion of the rear housing 312. The control unit 340 comprises a control board 342 and a controller casing 344 housing the control board 342 therein. The control board 342 includes for example a microcomputer including a CPU, a ROM, and a RAM and an inverter circuit including a plurality of switching elements (e.g., FETs). For example, the control unit 340 is configured to convert DC power from the battery pack B′ to three-phase AC power and supply it to the electric motor 320.

The rear housing 312 comprises a substantially cylindrical shaft portion 346. The shaft portion 346 is located in a front portion of the rear housing 312. The base 306 comprises a shaft holding portion 348 that holds the shaft portion 346 such that the shaft portion 346 is rotatable about a rotation axis RA′. The shaft holding portion 348 is located in the rear portion of the base 306. The rotation axis RA′ lies on a plane orthogonal to the right-left direction and is inclined downward from the rear toward the front. In the right side view, an inclination angle θ′ of the rotation axis RA′ relative to the front-rear direction is for example in the range from 0 degrees to 30 degrees, and it is 10 degrees in this embodiment.

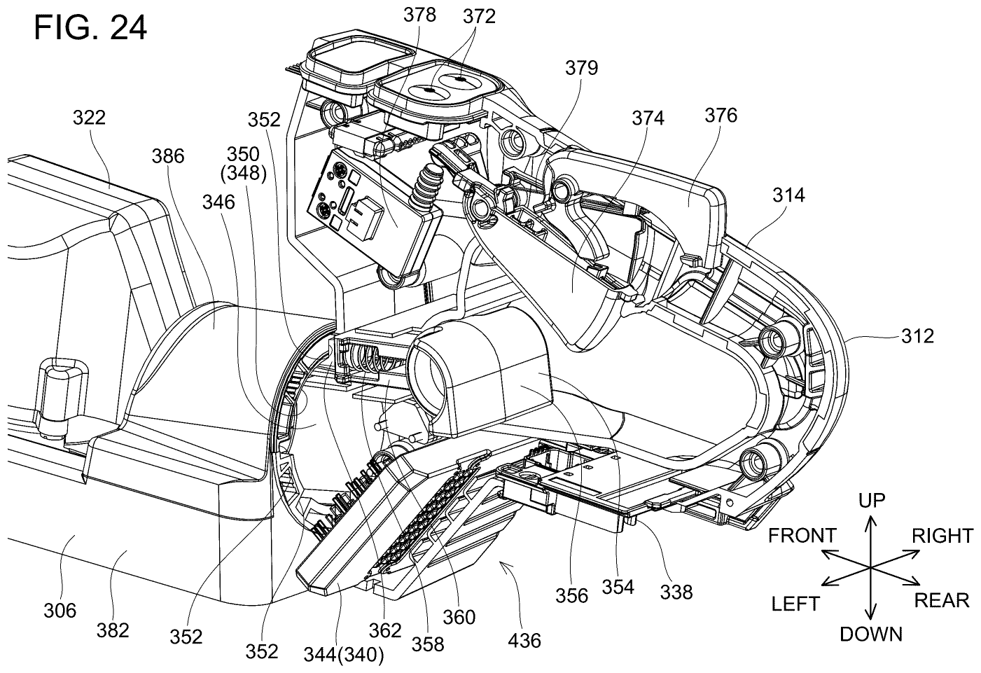

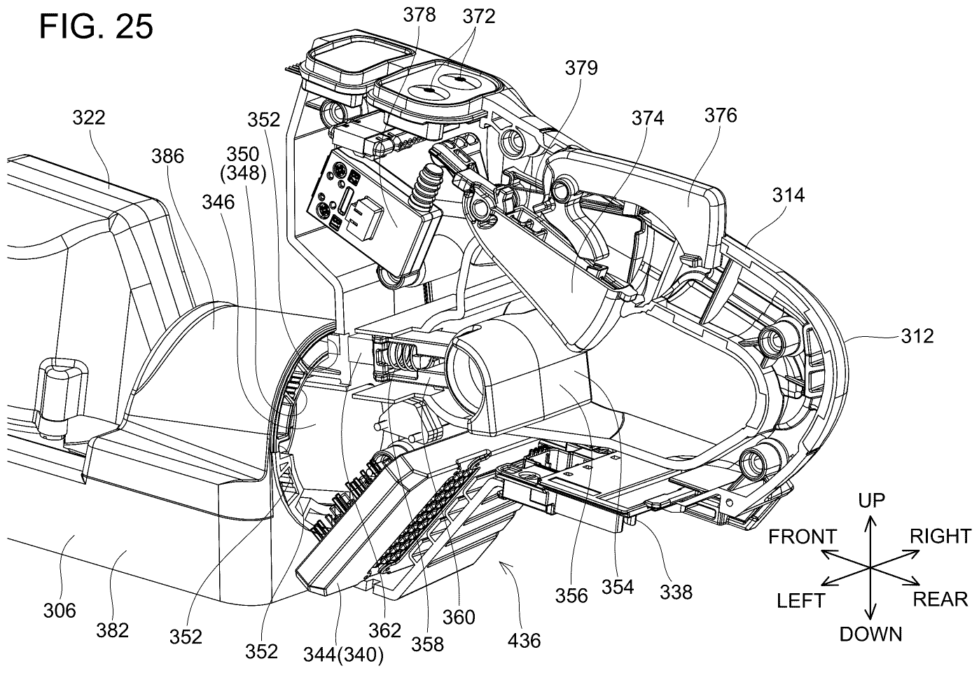

As shown in FIG. 24, the shaft holding portion 348 comprises a cylindrical surface 350 that holds the outer circumferential surface of the shaft portion 346 such that the shaft portion 346 is rotatable and a plurality of engagement grooves 352 (only partially shown) recessed from the cylindrical surface 350 in a radially outward direction of the rotation axis RA′ (see FIG. 23). A rotation locking member 354 is located on the rear housing 312, and the rotation locking member 354 is configured to lock the rotation of the shaft portion 346 relative to the base 306 (i.e., the rotation of the rear housing 312 relative to the base 306). The rotation locking member 354 comprises a manipulation member 356 configured to allow finger(s) of the user to be placed thereon for manipulation, a spring housing member 360 that houses a coil spring 358, and a lock piece 362 extending forward from the front end of the spring housing member 360. The manipulation member 356 is located outside the rear housing 312. The spring housing member 360 and the lock piece 362 are located inside the rear housing 312. The rotation locking member 354 is usually in a lock position in which the lock piece 362 is received in one of the engagement grooves 352 (i.e., the position shown in FIG. 24). The rotation locking member 354 is slidable in the front-rear direction between the lock position and an unlock position where the lock piece 362 is not received in any of the engagement grooves 352 as shown in FIG. 25. As shown in FIG. 23, the rear end of the coil spring 358 contacts a support projection 364 formed on the inner wall of the rear housing 312. The coil spring 358 biases the rotation locking member 354 forward relative to the support projection 364. Thus, while the user does not manipulate the manipulation member 356, the rotation locking member 354 is retained in the lock position shown in FIG. 24 by the biasing force of the coil spring 358. When the rotation locking member 354 is in the lock position, the rear housing 312 is mechanically locked to the base 306 and the rear housing 312 is thereby prohibited from rotating relative to the base 306. When the user pulls the manipulation member 356 rearward against the biasing force of the coil spring 358, the rotation locking member 354 moves to the unlock position shown in FIG. 25. When the rotation locking member 354 is in the unlock position, the lock of the rear housing 312 to the base 306 is released and the rear housing 312 is thereby permitted to rotate relative to the base 306.

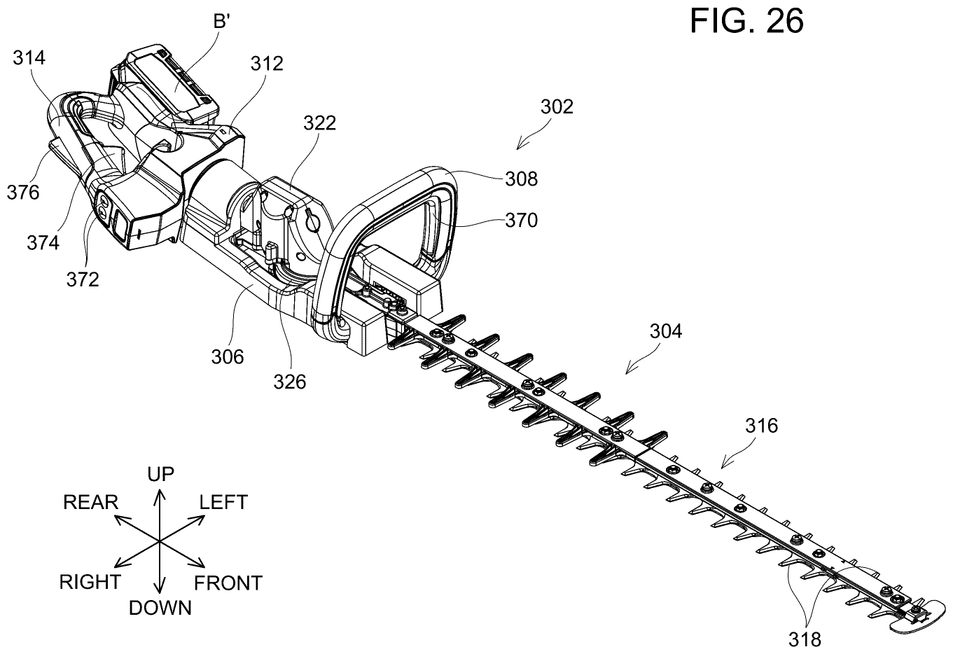

The user can change the position of the rear housing 312 relative to the base 306 by rotating the rear housing 312 to engage the lock piece 362 with another engagement groove 352 after the rotation locking member 354 has moved to the unlock position. Thereby, the position of the rear housing 312 can be changed from the normal position shown in FIG. 22 to for example a rotated position shown in FIG. 26. Thus, the user can adjust the positional relationship between the front handle 308 and the rear handle 314 to hold the hedge trimmer 302 in a comfortable posture. When the rear housing 312 is in the normal position as shown in FIG. 22, the lower surface of the base 306 is substantially flush with the lower surface of the rear housing 312. Thus, as shown in FIG. 23, the hedge trimmer 302 can be placed on a flat surface P such as the ground with the lower surface of the base 306 and the lower surface of the rear housing 312 directed vertically downward. In this embodiment, the lower surface of the base 306 and the lower surface of the rear housing 312 when the rear housing 312 is in the normal position may be termed a bottom surface 366 of the base 306 and a bottom surface 368 of the rear housing 312, respectively. In the following description, the rear housing 312 is in the normal position, unless otherwise stated.

As shown in FIG. 23, a grip detection lever 370 is located on the outer surface of the front handle 308 and the grip detection lever 370 is configured to be manipulated with finger(s) of the user's hand gripping the front handle 308. A grip detection switch 371 is located within the front handle 308 and the grip detection switch 371 is pressed when the grip detection lever 370 is manipulated. The grip detection switch 371 is configured to detect manipulation on the grip detection lever 370.

As shown in FIG. 24, a manipulation button 372, a trigger lever 374, and a lock-off lever 376 are located on the rear housing 312. The manipulation button 372 is located on the upper surface of the rear handle 314. By manipulating the manipulation button 372, the user can switch on/off of the main power of the hedge trimmer 302, change the rotation speed of the electric motor 320, cause the electric motor 320 to rotate in the reverse direction, etc. The trigger lever 374 is located on a lower portion of the rear handle 314 such that the user can manipulate it with the index finger of the hand grasping the rear handle 314. The lock-off lever 376 is located on an upper portion of the rear handle 314 such that the user can manipulate it with the palm of the hand grasping the rear handle 314. The trigger lever 374 is usually mechanically locked by the lock-off lever 376. When the lock-off lever 376 is pushed, the trigger lever 374 is unlocked and thereby permitted to be pulled up. When the trigger lever 374 is pulled up, a microswitch 378 housed in the rear housing 312 is thereby pressed. When the trigger lever 374 is released, the trigger lever 374 is returned to the initial position (the position shown in FIG. 24) by the biasing force of a torsion spring 379 and the pressing on the microswitch 378 is released. The microswitch 378 is configured to detect the manipulation on the trigger lever 374.

When the microswitch 378 and the grip detection switch 371 (see FIG. 23) are pressed while the main power of the hedge trimmer 302 is on, the control unit 340 actuates the electric motor 320 (see FIG. 23) to drive the pair of shear blades 316 (see FIG. 23). In response to the pressing on at least one of the microswitch 378 and the grip detection switch 371 being released, the control unit 340 stops the electric motor 320 to stop the pair of shear blades 316. As above, the user can actuate the pair of shear blades 316 by pushing the lock-off lever 376 and the grip detection lever 370 (see FIG. 23) and pulling up the trigger lever 374 while the main power of the hedge trimmer 302 is on.

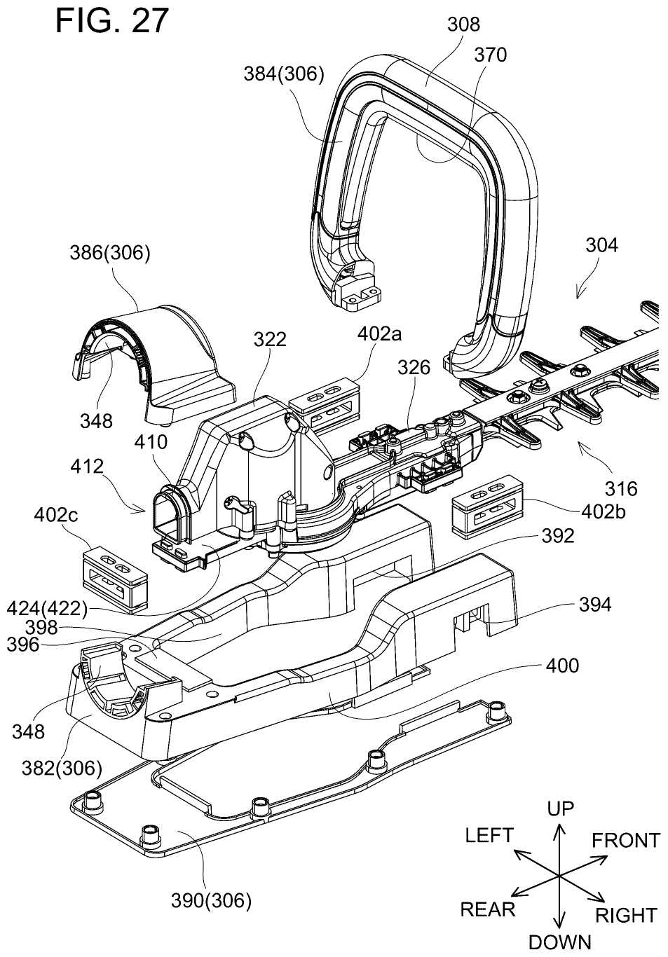

As shown in FIG. 27, the base 306 comprises a base body 382, a handle member 384, a semicylindrical member 386, and a bottom plate 390. The base body 382, the handle member 384, the semicylindrical member 386, and the bottom plate 390 are fixed to each other with screws (not shown). The handle member 384 forms the front handle 308. The base 306 comprises a left support 392 supporting a left portion of the mechanism housing 326 via a vibration damping member 402a, a right support 394 supporting a right portion of the mechanism housing 326 via a vibration damping member 402b, a rear support 396 supporting a rear portion of the mechanism housing 326 via a vibration damping member 402c, a left arm 398 extending on the left side of the mechanism housing 326 and connecting the left support 392 to the rear support 396, and a right arm 400 extending on the right side of the mechanism housing 326 and connecting the right support 394 to the rear support 396.

The vibration damping members 402a, 402b, 402c are substantially the same as the vibration damping members 90a, 90b, 90c described in the first embodiment. Further, the base 306 supports the mechanism housing 326 via the vibration damping members 402a, 402b, 402c substantially in the same way as the base 6 supports the mechanism housing 26 via the vibration damping members 90a, 90b, 90c in the first embodiment. Thus, the description in connection with the first embodiment should be referred to for details for these.

### Cooling Configuration of Hedge Trimmer 302

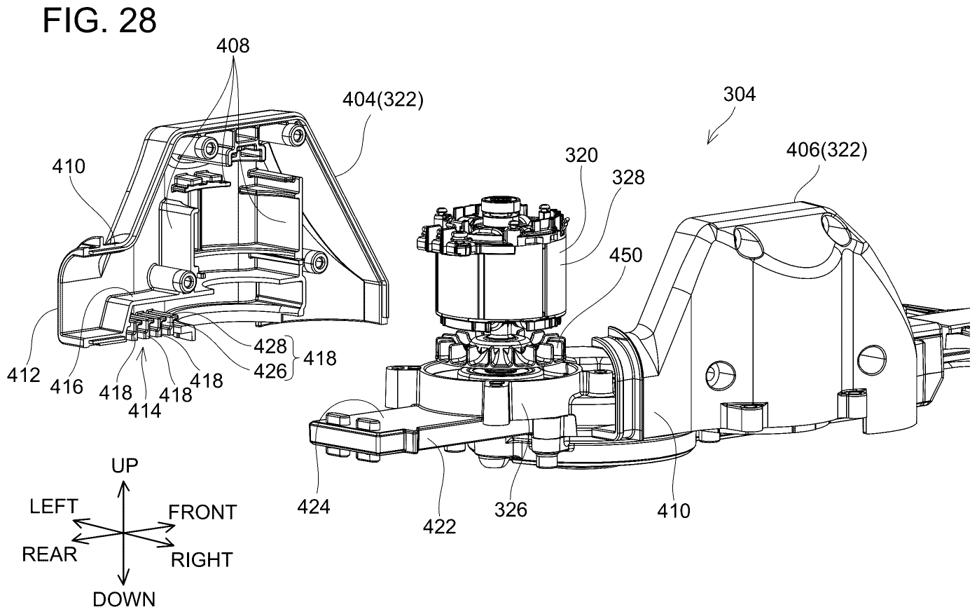

As shown in FIG. 28, the motor housing 322 is constituted of a left housing member 404 and a right housing member 406. The left housing member 404 and the right housing member 406 are fixed to each other with screws (not shown). A motor supporting frame 408 is formed on the inner wall of the motor housing 322. The motor supporting frame 408 is in contact with the outer surface of the stator 328 to support the electric motor 320. The motor supporting frame 408 is divided to a portion formed on the left housing member 404 and a portion formed on the right housing member 406 (not shown). When the motor housing 322 is removed, the outer surface of the stator 328 is exposed to the outside of the hedge trimmer 302.

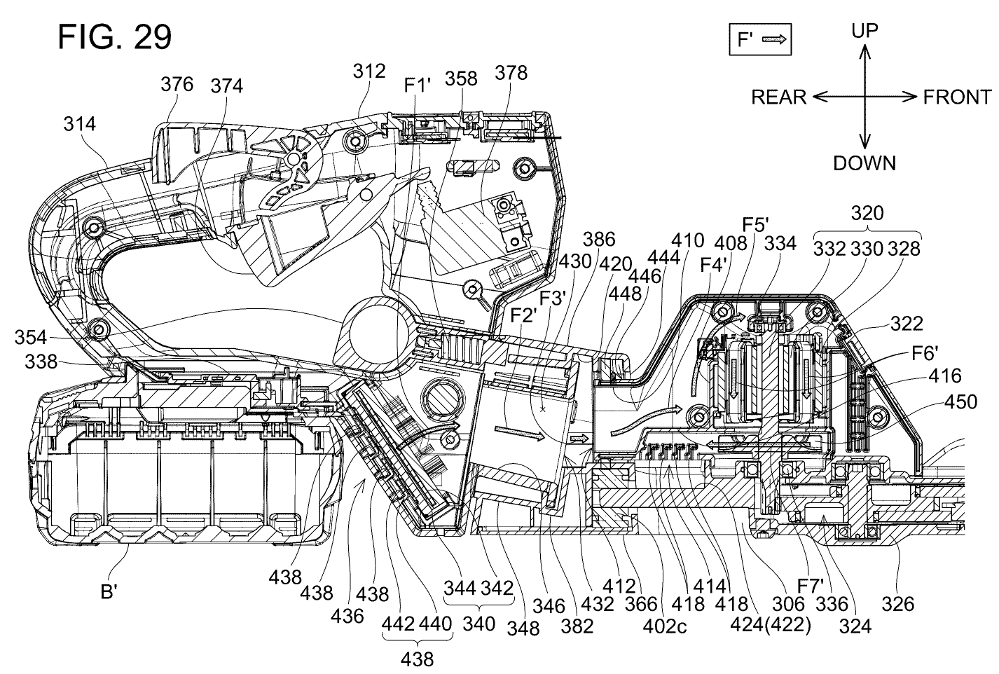

As shown in FIG. 29, the motor housing 322 comprises a duct 410 extending rearward from the electric motor 320, an air inlet 412 defined at the rear end of the duct 410, an air outlet 414 defined in the lower surface of the motor housing 322, a separator wall 416 that separates the air inlet 412 from the air outlet 414 within the motor housing 322, and a plurality of ribs 418 located near the air outlet 414.

The air inlet 412 opens to the inside of a passage 420 defined in the base 306 along the front-rear direction. The air outlet 414 opens to the outside of the hedge trimmer 302 along the up-down direction. The direction from the inside to the outside of the hedge trimmer 302 via the air outlet 414 is along the down direction (i.e., the direction in which the bottom surface 366 of the base 306 faces). The air outlet 414 faces an upper surface 424 of a mount frame 422 of the mechanism housing 326. The mount frame 422 corresponds to the mount frame 170 (see FIG. 14) in the first embodiment. The upper surface 424 of the mount frame 422 is a plane parallel to the front-rear direction and the right-left direction and is offset downward from the air outlet 414 (the lower surface of the motor housing 322). The distance between the upper surface 424 of the mount frame 422 and the air outlet 414 (i.e., the lower surface of the motor housing 322) is for example in the range from 5 mm to 30 mm, and it is 12 mm in this embodiment. The ribs 418 are aligned in a direction (the front-rear direction) perpendicular to the opening direction of the air outlet 414 (the up-down direction). As shown in FIG. 28, each rib 418 comprises a first wall 426 extending in the up-down direction and a second wall 428 extending forward from the upper end of the first wall 426. When foreign matters (e.g., dust, chips, etc.) enter the air outlet 414, the ribs 418 block the foreign matters by the second walls 428 and thus prevent the foreign matters from entering the motor housing 322 beyond the ribs 418.

As shown in FIG. 29, the rear housing 312 comprises a through hole 430 that extends through the shaft portion 346 and communicates the inside of the rear housing 312 with the outside thereof, an air outlet 432 which is the front opening of the through hole 430, and an air inlet 436 facing the front surface of the battery pack B′ attached to the battery receptacle 338.

The air outlet 432 opens to the inside of the passage 420 defined in the base 306 along the extending direction of the rotation axis RA′ (see FIG. 23). The air inlet 436 is defined in an outer wall of the rear housing 312 and opens to the outside of the hedge trimmer 302. The direction from the outside to the inside of the hedge trimmer 302 via the air inlet 436 is an obliquely upward direction from the rear toward the front. A plurality of ribs 438 is located near the air inlet 436. The ribs 438 are aligned in a direction (an obliquely downward direction from the rear toward the front) perpendicular to the opening direction of the air inlet 436. Each rib 438 comprises a first wall 440 extending forward and upward from the outer wall of the rear housing 312 and a second wall 442 extending rearward and upward from the upper end of the first wall 440. When foreign matters (e.g., dust, chips, etc.) enter the air inlet 436, the ribs 438 block the foreign matters by the second walls 442 and thus prevent the foreign matters from entering the motor housing 322 beyond the ribs 438.

The passage 420 is located forward of the shaft holding portion 348. The passage 420 and the shaft holding portion 348 are partially in the base body 382 and partially in the semicylindrical member 386. An opening 444 is defined at the front end of the passage 420 and the duct 410 of the motor housing 322 is inserted to the opening 444. There is a clearance 446 between the outer surface of the duct 410 and the inner surface of the passage 420. Without the clearance 446, the motor housing 322 would contact the base 306, which results in direct vibration transmission from the working unit 304 to the base 306. The clearance 446 prevents the motor housing 322 from contacting the semicylindrical member 386, thereby preventing direct vibration transmission from the working unit 304 to the base 306. The clearance 446 is closed by a dust blocking member (not shown). A material that barely transmits vibrations (e.g., sponge) is used for the dust blocking member. This prevents foreign particles such as dust from entering the hedge trimmer 302 through the clearance 446.

The hedge trimmer 302 comprises a cooling air passage F′ extending from the air inlet 436 in the rear housing 312 to the air outlet 414 in the motor housing 322 via the inside of the rear housing 312, the air outlet 432 in the rear housing 312, the inside of the passage 420, the air inlet 412 in the motor housing 322, and the inside of the motor housing 322. In this embodiment, a fan 450 is fixed to the output shaft 332 and the fan 450 generates an air flow (which may be simply termed cooling air) along the cooling air passage F′. The fan 450 is located below the rotor 330. When the electric motor 320 operates, the fan 450 rotates with the output shaft 332, thereby generating the cooling air in the cooling air passage F′.

The cooling air passage F′ comprises a first passage section F1′ in which air flows from the air inlet 436 via a lower front portion of the rear housing 312 to the through hole 430, a second passage section F2′ in which the air flows through the through hole 430 to the air outlet 432, a third passage section F3′ in which the air flows from the air outlet 432 via the inside of the passage 420 to the air inlet 412, a fourth passage section F4′ in which the air flows from the air inlet 412 forward via the inside of the duct 410 and a space above the separator wall 416, a fifth passage section F5′ in which the air flows along the rear surface of the motor supporting frame 408 to an upper portion of the motor housing 322, a sixth passage section F6′ in which the air flows downward from the upper portion of the motor housing 322 via spacing between the stator 328 and the rotor 330 of the electric motor 320, and a seventh passage section F7′ in which the air flows toward the air outlet 414 via a space below the separator wall 416.

The control unit 340 is located in the first passage section F1′ to face the air inlet 436. Specifically, the control unit 340 is located such that its longitudinal direction is perpendicular to the opening direction of the air inlet 436 (along the obliquely downward direction from the rear toward the front). Since cooling air flows around the control unit 340 when the fan 450 rotates, heat around the control unit 340 is taken away by the cooling air to the air outlet 414. Thus, the control unit 340 can be efficiently cooled.

As the inside of the passage 420 is viewed in the front-rear direction, the air inlet 412 of the motor housing 322 and the air outlet 432 of the rear housing 312 overlap each other. This allows the cooling air to smoothly flows in the third passage section F3′.

Electric wires electrically connecting electric components housed in the rear housing 312 to electric components housed in the motor housing 322 are located in the cooling air passage F′, although this is not shown. For example, an electric wire electrically connecting the control unit 340 housed in the rear housing 312 to the electric motor 320 housed in the motor housing 322 is located in the cooling air passage F′.

### Variants

The working machine may be a working machine other than the hedge trimmer 302 (e.g., a reciprocating saw, a chainsaw, a grass trimmer). In this case, the working unit 304 may comprise, instead of the pair of shear blades 316, another working mechanism (e.g., a saw, a saw chain, a rotary blade).

The hedge trimmer 302 may reciprocate only one of the shear blades 316 instead of reciprocating both of the shear blades 316.

The prime mover configured to drive the pair of shear blades 316 may be a prime mover other than the electric motor 320 (e.g., an engine with a combustion mechanism).

Instead of the battery receptacle 338, a power cable for connection to an external power supply (e.g., a commercial power supply or a backpack-type power supply) may be located on the rear housing 312. In this case, the hedge trimmer 302 may operate with electric power supplied through the power cable from the external power supply.

The electric motor 320 may be a motor other than the inner rotor brushless motor (e.g., an outer rotor brushless motor, a brush motor, or the like).

The base 306 may house the motor housing 322 and the mechanism housing 326. In this case, the motor housing 322 and the mechanism housing 326 may be invisible when the hedge trimmer 302 is viewed from the outside.

(See FIG. 29.) The control unit 340 may not be located in the first passage section F1′. For example, the control unit 340 may be located in the second passage section F2′. Alternatively, the control unit 340 may not be located in the cooling air passage F′. For example, the control unit 340 may be located upward of the battery receptacle 338 to face the battery receptacle 338.

(See FIG. 24.) The rear housing 312 may be attached to the base 306 such that it cannot rotate. In this case, the hedge trimmer 302 may not comprise elements such as the rotation locking member 354, the plurality of engagement grooves 352, etc.

(See FIG. 28.) A member that covers the electric motor 320 (e.g., a cylindrical cover extending along the outer surface of the stator 328) may be provided between the motor housing 322 and the electric motor 320. In this case, the outer surface of the stator 328 may not be exposed to the outside of the hedge trimmer 302 even whether motor housing 322 is removed.

(See FIG. 28.) The hedge trimmer 302 may not comprise a component that faces the air outlet 414 from the outside of the hedge trimmer 302 (e.g., the mount frame 422 of the mechanism housing 326).

(See FIG. 28.) The air outlet 414 may be defined in a surface other than the lower surface of the motor housing 322 (e.g., the front surface, left surface, upper surface, or the like of the motor housing 322). Accordingly, the direction from the inside to the outside of the hedge trimmer 302 via the air outlet 414 may be a direction other than the down direction (e.g., the front direction or the left direction). In this case, the mechanism housing 326 may further comprise a wall surface that faces the air outlet 414. This wall surface suppresses foreign matters (e.g., dust, chips, etc.) outside the hedge trimmer 302 from reaching the air outlet 414 and reduces the speed of air flowing out of the air outlet 414.

(See FIG. 28.) The air inlet 436 may be defined such that it does not face the battery pack B′ attached to the battery receptacle 338. For example, the air inlet 436 may be defined in the rear surface, left surface, or upper surface of the rear housing 312.

### Features of Second Embodiment

As described, in one or more embodiments, the hedge trimmer 302 (an example of working machine) comprise the working unit 304 including the pair of shear blades 316 (an example of working mechanism), the electric motor 320 configured to drive the pair of shear blades 316, and the motor housing 322 that houses the electric motor 320, the control unit 340 configured to control the electric motor 320, the base 306 supporting the working unit 304, the rear housing 312 attached to the rear portion of the base 306, the front handle 308 disposed on the base 306 and configured to be grasped by the user with one hand of the user, and the rear handle 314 disposed on the rear housing 312 and configured to be grasped by the user with the other hand of the user. The base 306 comprises the passage 420. The motor housing 322 comprises the air inlet 412 (an example of inner air inlet) that opens to the inside of the passage 420 and the air outlet 414 (an example of outer air outlet) that opens to the outside of the hedge trimmer 302. The rear housing 312 comprises the air inlet 436 (an example of outer air inlet) that opens to the outside of the hedge trimmer 302 and the air outlet 432 (an example of inner air outlet) that opens to the inside of the passage 420. The cooling air passage F′ is defined in which air flows from the air inlet 436 to the air outlet 414 through the inside of the rear housing 312, the air outlet 432, the inside of the passage 420, the air inlet 412, and the inside of the motor housing 322. As viewed along the front-rear direction, the air inlet 412 and the air outlet 432 overlap each other.

If the air inlet 412 and the air outlet 432 do not overlap each other as viewed along the front-rear direction, air flowing out of the air outlet 432 may not smoothly flow into the air inlet 412. This may lead to an insufficient amount of cooling air and thus may result in insufficient cooling for the electric motor 320. Since the air inlet 412 and the air outlet 432 overlap each other as viewed along the front-rear direction in the configuration above, air flowing out of the air outlet 432 smoothly flows into the air inlet 412. This increases the amount of cooling air, and thus the electric motor 320 can thereby be sufficiently cooled. Further, since the air inlet 436, which opens to the outside of the hedge trimmer 302, is defined in the rear housing 312 located far from the pair of shear blades 316 in the above configuration, foreign matters dispersed due to the operation of the pair of shear blades 316 are prevented from entering the hedge trimmer 302.

In one or more embodiments, the control unit 340 is housed in the rear housing 312 and located in the cooling air passage F′.

The configuration above allows not only the electric motor 320 but also the control unit 340 to be cooled by the cooling air.

In one or more embodiments, the rear housing 312 is attached to the base 306 such that the rear housing 312 is rotatable about the predetermined rotation axis RA′. The rear housing 312 is movable relative to the base 306 between the normal position and the rotated position in which the rear housing 312 has been rotated about the rotation axis RA′ from the normal position.

The configuration above allows the user to change the position of the rear housing 312 relative to the base 306 to change the positional relationship between the front handle 308 and the rear handle 314. For example, the user can change the positional relationship between the front handle 308 and the rear handle 314 to hold the hedge trimmer 302 in a comfortable posture.

In one or more embodiments, the rear housing 312 comprises the shaft portion 346 extending along the rotation axis RA′. The base 306 comprises the shaft holding portion 348 that holds the shaft portion 346 such that the shaft portion 346 is rotatable about the rotation axis RA′. The shaft portion 346 comprises the through hole 430 that extends through the shaft portion 346 to communicate the inside of the rear housing 312 with the outside of the rear housing 312. An opening of the through hole 430 that is directed toward the outside of the rear housing 312 functions as the air outlet 432.

If the air outlet 432 is located far from the rotation axis RA′, the positional relationship between the air inlet 412 and the air outlet 432 is significantly changed when the rear housing 312 is rotated relative to the base 306. Thus, depending on the position of the rear housing 312 relative to the base 306, the air flowing out of the air outlet 432 may not smoothly flow into the air inlet 412. In the configuration above, the air outlet 432 is located near the rotation axis RA′ since the air outlet 432 is defined in the shaft portion 346. Therefore, the positional relationship between the air inlet 412 and the air outlet 432 is not changed much even when the rear housing 312 is rotated relative to the base 306. Thus, the configuration above can smoothly guide the air flowing out of the air outlet 432 into the air inlet 412, regardless of the position of the rear housing 312 relative to the base 306.

In one or more embodiments, the electric motor 320 is an inner rotor brushless motor comprising the stator 328, the rotor 330 located inward of the stator 328, and the output shaft 332 fixed to the rotor 330. When the motor housing 322 is removed from the hedge trimmer 302, the outer surface of the stator 328 is exposed to the outside of the hedge trimmer 302.

If the outer surface of the stator 328 is covered by a member different from the motor housing 322, heat may not be released from the electric motor 320. The configuration above allows release of heat from the electric motor 320 since the motor housing 322 is the only member that covers the outer surface of the stator 328.

In one or more embodiments, the working mechanism comprises the pair of shear blades 316 (an example of a pair of blades) extending in the front-rear direction. The shear blades 316 are configured to reciprocate relative to each other in the front-rear direction when driven by the electric motor 320.

The configuration above prevents foreign matters dispersed due to the operation of the pair of shear blades 316 from entering the inside of the hedge trimmer 302, while sufficiently cooling the electric motor 320.

In one or more embodiments, the working unit 304 further comprises the mechanism housing 326 supporting the pair of shear blades 316. The mechanism housing 326 comprises the upper surface 424 (an example of facing surface) exposed to the outside of the hedge trimmer 302 and facing the air outlet 414.

In the configuration above, the mechanism housing 326 is located to face the air outlet 414. This makes foreign matters (e.g., dust, chips) outside the hedge trimmer 302 unlikely to reach the air outlet 414 and thus suppresses the entry of foreign matters through the air outlet 414 from the outside into the inside of the hedge trimmer 302. Further, in the configuration above, the speed of air from the air outlet 414 is reduced immediately after the air flows out of the air outlet 414 by the air hitting the upper surface of the mount frame 422. This prevents the air from the air outlet 414 from bursting toward the user's body and thus prevents the user from feeling uncomfortable.

In one or more embodiments, the base 306 comprises the bottom surface 366 that faces the flat surface P when the hedge trimmer 302 is placed on the flat surface P. The direction from the inside of the hedge trimmer 302 to the outside of the hedge trimmer 302 via the air outlet 414 (the down direction) is along the direction in which the bottom surface 366 of the base 306 faces (the down direction).

Generally, a handle configured to be gripped by the user, etc. is not located on the bottom surface 366 of the base 306. Therefore, when the user uses the hedge trimmer 302, the user's body is not expected to be in a space the bottom surface 366 of the base 306 faces. In the configuration above, the direction from the inside to the outside of the hedge trimmer 302 via the air outlet 414 (i.e., the direction in which the air from the air outlet 414 flows) is toward the space the bottom surface 366 of the base 306 faces (i.e., the space in which the user's body is not expected to exist). This prevents the air from the air outlet 414 from bursting toward the user's body and thus prevents the user from feeling uncomfortable.

In one or more embodiments, the rear housing 312 comprises the battery receptacle 338 to which the battery pack B′ is detachably attached. The air inlet 436 faces the battery pack B′ attached to the battery receptacle 338.

In the configuration above, the battery pack B′ is located to face the air inlet 436. This makes foreign matters (e.g., dust, chips) outside the hedge trimmer 302 unlikely to reach the air inlet 436 and thus suppresses the entry of foreign matters through the air inlet 436 from the outside into the inside of the hedge trimmer 302.

What is claimed is:

1. A working machine, comprising:
a working unit including a working mechanism, an electric motor configured to drive the working mechanism, and a motor housing that houses the electric motor;
a control unit configured to control the electric motor;
a base supporting the working unit;
a rear housing attached to a rear portion of the base;
a front handle disposed on the base and configured to be grasped by a user with one hand of the user; and
a rear handle disposed on the rear housing and configured to be grasped by the user with the other hand of the user,
wherein
the base comprises a passage,
the motor housing comprises an inner air inlet that opens to an inside of the passage and an outer air outlet that opens to outside of the working machine,
the rear housing comprises an outer air inlet that opens to the outside of the working machine and an inner air outlet that opens to the inside of the passage,
a cooling air passage is defined in which air flows from the outer air inlet to the outer air outlet through an inside of the rear housing, the inner air outlet, the inside of the passage, the inner air inlet, and an inside of the motor housing, and
as viewed along a front-rear direction, the inner air inlet and the inner air outlet overlap each other.

2. The working machine according to claim 1, wherein
the control unit is housed in the rear housing and located in the cooling air passage.

3. The working machine according to claim 2, wherein
the cooling air passage comprises a passage section defined in the rear housing and extending in the front-rear direction, and
the control unit is located in the passage section such that a longitudinal direction of the control unit is along the front-rear direction.

4. The working machine according to claim 1, wherein
the rear housing is attached to the base such that the rear housing is rotatable about a predetermined rotation axis, and
the rear housing is movable relative to the base between a normal position and a rotated position in which the rear housing has been rotated about the rotation axis from the normal position.

5. The working machine according to claim 4, wherein
the rear housing comprises a shaft portion extending along the rotation axis,
the base comprises a shaft holding portion that holds the shaft portion such that the shaft portion is rotatable about the rotation axis,
the shaft portion comprises a through hole that extends through the shaft portion to communicate the inside of the rear housing with outside of the rear housing, and
an opening of the through hole that is directed toward the outside of the rear housing functions as the inner air outlet.

6. The working machine according to claim 1, wherein
the electric motor is an inner rotor brushless motor comprising a stator, a rotor located inward of the stator, and an output shaft fixed to the rotor, and
when the motor housing is removed from the working machine, an outer surface of the stator is exposed to the outside of the working machine.

7. The working machine according to claim 1, wherein
the working mechanism comprises a pair of blades extending in the front-rear direction, and
the blades are configured to reciprocate relative to each other in the front-rear direction when driven by the electric motor.

8. The working machine according to claim 1, wherein
the working unit further comprises a mechanism housing supporting the working mechanism, and
the mechanism housing comprises a facing surface exposed to the outside of the working machine and facing the outer air outlet.

9. The working machine according to claim 1, wherein
the base comprises a bottom surface that faces a flat surface when the working machine is placed on the flat surface, and
a direction from an inside of the working machine to the outside of the working machine via the outer air outlet is along a direction in which the bottom surface faces.

10. The working machine according to claim 1, wherein
the rear housing comprises a battery receptacle to which a battery pack is detachably attached, and
the outer air inlet faces the battery pack attached to the battery receptacle.

11. The working machine according to claim 3, wherein
the rear housing is attached to the base such that the rear housing is rotatable about a predetermined rotation axis,
the rear housing is movable relative to the base between a normal position and a rotated position in which the rear housing has been rotated about the rotation axis from the normal position,
the rear housing comprises a shaft portion extending along the rotation axis,
the base comprises a shaft holding portion that holds the shaft portion such that the shaft portion is rotatable about the rotation axis,
the shaft portion comprises a through hole that extends through the shaft portion to communicate the inside of the rear housing with outside of the rear housing,
an opening of the through hole that is directed toward the outside of the rear housing functions as the inner air outlet,
the electric motor is an inner rotor brushless motor comprising a stator, a rotor located inward of the stator, and an output shaft fixed to the rotor,
when the motor housing is removed from the working machine, an outer surface of the stator is exposed to the outside of the working machine,
the working mechanism comprises a pair of blades extending in the front-rear direction,
the blades are configured to reciprocate relative to each other in the front-rear direction when driven by the electric motor,
the rear housing comprises a battery receptacle to which a battery pack is detachably attached,
in a state where the battery pack is attached to the battery receptacle, the battery pack is located on the rotation axis,
in a state where the rear housing is in the normal position, the battery receptacle is located in the rear portion of the rear housing,
in a state where the rear housing is in the normal position and the battery pack is attached to the battery receptacle, a center of gravity of the battery pack is located rearward of a rear end of the rear handle,
in a state where the rear housing is in the normal position, the rear handle is located on an upper portion of the rear housing and extends in the front-rear direction,
in a state where the rear housing is in the normal position, the battery pack is attached to the battery receptacle by being slid relative to the battery receptacle in a sliding direction from an upper rear end of the battery receptacle toward a lower front end of the battery receptacle.
in a state where the rear housing is in the normal position and the battery pack is attached to the battery receptacle, a center of gravity of the working machine is located rearward of a rear end of the front handle and forward of a front end of the rear handle,
as viewed along a direction of the rotation axis, the rear housing and the battery pack are located within an imaginary circle with a radius of 13 cm about the rotation axis,
the base comprises:
a front support supporting the working mechanism;
a rear support supporting the working mechanism and located rearward of the front support; and
an arm extending on a side of the working mechanism and connecting the front support to the rear support, and
the arm comprises:
a left arm extending on a left side of the working mechanism and connecting the front support to the rear support; and
a right arm extending on a right side of the working mechanism and connecting the front support to the rear support.

12. The working machine according to claim 2, wherein
the rear housing is attached to the base such that the rear housing is rotatable about a predetermined rotation axis,
the rear housing is movable relative to the base between a normal position and a rotated position in which the rear housing has been rotated about the rotation axis from the normal position,
the rear housing comprises a shaft portion extending along the rotation axis,
the base comprises a shaft holding portion that holds the shaft portion such that the shaft portion is rotatable about the rotation axis,
the shaft portion comprises a through hole that extends through the shaft portion to communicate the inside of the rear housing with outside of the rear housing,
an opening of the through hole that is directed toward the outside of the rear housing functions as the inner air outlet,
the electric motor is an inner rotor brushless motor comprising a stator, a rotor located inward of the stator, and an output shaft fixed to the rotor,
when the motor housing is removed from the working machine, an outer surface of the stator is exposed to the outside of the working machine,
the working mechanism comprises a pair of blades extending in the front-rear direction,
the blades are configured to reciprocate relative to each other in the front-rear direction when driven by the electric motor,
the working unit further comprises a mechanism housing supporting the working mechanism,
the mechanism housing comprises a facing surface exposed to the outside of the working machine and facing the outer air outlet,
the base comprises a bottom surface that faces a flat surface when the working machine is placed on the flat surface,
a direction from an inside of the working machine to the outside of the working machine via the outer air outlet is along a direction in which the bottom surface faces,
the rear housing comprises a battery receptacle to which a battery pack is detachably attached, and
the outer air inlet faces the battery pack attached to the battery receptacle.

13. A working machine, comprising:
an electric motor;
a working mechanism configured to be driven by the electric motor;
a base supporting the working mechanism;
a rear housing that is attached to a rear portion of the base such that the rear housing is rotatable about a predetermined rotation axis and is movable relative to the base between a normal position and a rotated position in which the rear housing has been rotated about the rotation axis from the normal position;
a front handle disposed on the base and configured to be grasped by a user with one hand of the user;
a rear handle disposed on the rear housing and configured to be grasped by the user with the other hand of the user; and
a battery receptacle disposed in the rear housing and to which a battery pack is detachably attached,
wherein
in a state where the battery pack is attached to the battery receptacle, the battery pack is located on the rotation axis.

14. The working machine according to claim 13, wherein
in a state where the rear housing is in the normal position, the battery receptacle is located in the rear portion of the rear housing.

15. The working machine according to claim 14, wherein
in a state where the rear housing is in the normal position and the battery pack is attached to the battery receptacle, a center of gravity of the battery pack is located rearward of a rear end of the rear handle.

16. The working machine according to claim 13, wherein
in a state where the rear housing is in the normal position,
the rear handle is located on an upper portion of the rear housing and extends in a front-rear direction, and
the battery pack is attached to the battery receptacle by being slid relative to the battery receptacle in a sliding direction from an upper rear end of the battery receptacle toward a lower front end of the battery receptacle.

17. The working machine according to claim 13, wherein
in a state where the rear housing is in the normal position and the battery pack is attached to the battery receptacle, a center of gravity of the working machine is located rearward of a rear end of the front handle and forward of a front end of the rear handle.

18. The working machine according to claim 13, wherein
as viewed along a direction of the rotation axis, the rear housing and the battery pack are located within an imaginary circle with a radius of 13 cm about the rotation axis.

19. The working machine according to claim 13, wherein
the base comprises:
a front support supporting the working mechanism;
a rear support supporting the working mechanism and located rearward of the front support; and
an arm extending on a side of the working mechanism and connecting the front support to the rear support.

20. The working machine according to claim 15, wherein
in a state where the rear housing is in the normal position, the rear handle is located on an upper portion of the rear housing and extends in a front-rear direction,
in a state where the rear housing is in the normal position, the battery pack is attached to the battery receptacle by being slid relative to the battery receptacle in a sliding direction from an upper rear end of the battery receptacle toward a lower front end of the battery receptacle.
in a state where the rear housing is in the normal position and the battery pack is attached to the battery receptacle, a center of gravity of the working machine is located rearward of a rear end of the front handle and forward of a front end of the rear handle,
as viewed along a direction of the rotation axis, the rear housing and the battery pack are located within an imaginary circle with a radius of 13 cm about the rotation axis,
the base comprises:
a front support supporting the working mechanism;
a rear support supporting the working mechanism and located rearward of the front support; and
an arm extending on a side of the working mechanism and connecting the front support to the rear support, and
the arm comprises:
a left arm extending on a left side of the working mechanism and connecting the front support to the rear support;
a right arm extending on a right side of the working mechanism and connecting the front support to the rear support,
the working mechanism comprises a pair of blades extending in the front-rear direction,
the blades are configured to reciprocate relative to each other in the front-rear direction when driven by the electric motor,
the working machine further comprises:
a motor housing that houses the electric motor; and
a control unit configured to control the electric motor,
the base comprises a passage,
the motor housing comprises an inner air inlet that opens to an inside of the passage and an outer air outlet that opens to outside of the working machine,
the rear housing comprises an outer air inlet that opens to the outside of the working machine and an inner air outlet that opens to the inside of the passage,
a cooling air passage is defined in which air flows from the outer air inlet to the outer air outlet through an inside of the rear housing, the inner air outlet, the inside of the passage, the inner air inlet, and an inside of the motor housing,
as viewed along the front-rear direction, the inner air inlet and the inner air outlet overlap each other,
the control unit is housed in the rear housing and located in the cooling air passage,
the cooling air passage comprises a passage section defined in the rear housing and extending in the front-rear direction,
the control unit is located in the passage section such that a longitudinal direction of the control unit is along the front-rear direction,
the rear housing comprises a shaft portion extending along the rotation axis,
the base comprises a shaft holding portion that holds the shaft portion such that the shaft portion is rotatable about the rotation axis,
the shaft portion comprises a through hole that extends through the shaft portion to communicate the inside of the rear housing with outside of the rear housing,
an opening of the through hole that is directed toward the outside of the rear housing functions as the inner air outlet,
the electric motor is an inner rotor brushless motor comprising a stator, a rotor located inward of the stator, and an output shaft fixed to the rotor, and
when the motor housing is removed from the working machine, an outer surface of the stator is exposed to the outside of the working machine.
